(19) United States
(12) Patent Application Publication
(10) Pub. No.: US 2019/0264620 A1
(43) Pub. Date: Aug. 29, 2019

(54) VALVE DEVICE

(71) Applicant: DENSO CORPORATION, Kariya-city (JP)

(72) Inventors: Yuichiro MORITANI, Kariya-city (JP); Takehiro SUGAWARA, Kariya-city (JP)

(21) Appl. No.: 16/406,176

(22) Filed: May 8, 2019

Related U.S. Application Data
(63) Continuation of application No. PCT/JP2017/036056, filed on Oct. 4, 2017.

(30) Foreign Application Priority Data
Nov. 29, 2016 (JP) 2016-230789
Aug. 30, 2017 (JP) 2017-166210

(51) Int. Cl. F02D 9/10; F04D 27/00; F01P 7/14; F16K 5/06

(52) U.S. Cl. CPC F02D 9/101; F16K 5/0694; F01P 7/14; F04D 27/009

(57) ABSTRACT

A valve device includes a valve housing, a valve member, a limiter portion and a contact portion. The valve housing includes an upstream-side flow passage, which is communicated with an intake passage, a receiving space, which is communicated with an EGR passage, a valve chamber, which communicates between the upstream-side flow passage and the receiving space, and a valve-housing-side seal portion, which is placed around an opening that communicates between the upstream-side flow passage and the receiving space. The valve member includes a valve-member-side seal portion, which blocks communication between the intake passage and the EGR passage when the valve-member-side seal portion contacts the valve-housing-side seal portion. The rotation of the valve member is limited when the contact portion contacts the limiter portion.

### CROSS REFERENCE TO RELATED APPLICATIONS

This application is a continuation application of International Patent Application No. PCT/JP2017/036056 filed on Oct. 4, 2017, which designated the U.S. and claims the benefit of priority from Japanese Patent Application No. 2016-230789 filed on Nov. 29, 2016 and Japanese Patent Application No. 2017-166210 filed on Aug. 30, 2017. The entire disclosures of all of the above applications are incorporated herein by reference.

### TECHNICAL FIELD

The present disclosure relates to a valve device.

### BACKGROUND

Previously, there is known a valve device that is placed in a flow passage for conducting fluid, and the valve device is configured to control flow of the fluid. The valve device includes: a valve housing, which has a flow passage; and a valve member, which is rotatable in an inside of the valve housing. In the valve device, the valve member includes a seal portion that blocks the flow passage when the seal portion contacts an edge portion of the valve housing that forms an opening of the flow passage.

### SUMMARY

A valve device of the present disclosure includes a valve housing and a valve member. The valve housing includes: a plurality of flow passages, through which fluid is flowable; a communication space, through which the plurality of flow passages is communicated relative to each other; and a valve-housing-side seal portion that is placed around an opening, which communicates between one of the plurality of flow passages and the communication space. The valve member is rotatable relative to the valve housing. The valve member includes a valve-member-side seal portion that blocks communication between the one of the plurality of flow passages and the communication space when the valve-member-side seal portion contacts the valve-housing-side seal portion.

According to the present disclosure, there is also provided a manufacturing method of the valve device.

### BRIEF DESCRIPTION OF DRAWINGS

The present disclosure, together with additional objectives, features and advantages thereof, will be best understood from the following description in view of the accompanying drawings.

FIG. 1 is a schematic diagram of an engine system, in which a valve device of a first embodiment is applied.

FIG. 2 is an external view of the valve device according to the first embodiment.

FIG. 3 is a view taken in a direction of an arrow III in FIG. 2.

FIG. 4 is a cross-sectional view taken along line IV-IV in FIG. 3.

FIG. 5 is a cross-sectional view showing a state where an EGR passage and a valve chamber are communicated with each other in the valve device of the first embodiment.

FIG. 6 is a cross-sectional view showing a state where the communication between the EGR passage and the valve chamber is blocked in the valve device of the first embodiment.

FIG. 7 is a perspective view of a tubular body of the valve device according to the first embodiment.

FIG. 8 is an exploded perspective view for describing a positional relationship between the tubular body and a valve member in the valve device of the first embodiment.

FIG. 9 is a partial cross-sectional view of the valve device according to the first embodiment.

FIG. 10 is a partial cross-sectional view of the valve device according to the first embodiment and serves as a partial cross-sectional view indicating a state that is different from a state of FIG. 9.

FIG. 11 is a partial cross-sectional view for describing a positional relationship between the tubular body and a valve member in the valve device of the first embodiment at sections (a) to (c) of FIG. 11.

FIG. 12 is a partial cross-sectional view of the valve device for describing a manufacturing method of the valve device according to the first embodiment.

FIG. 13 is an exploded perspective view of the valve device for describing the manufacturing method of the valve device according to the first embodiment.

FIG. 14 is a cross-sectional view of the valve device for describing the manufacturing method of the valve device according to the first embodiment and serves as a cross-sectional view for describing an initial step of the manufacturing method.

FIG. 15 is a cross-sectional view of the valve device for describing the manufacturing method of the valve device according to the first embodiment and serves as a cross-sectional view for describing a next step following the step of FIG. 14.

FIG. 16 is a schematic diagram for describing the manufacturing method of the valve device according to the first embodiment and serves as a schematic diagram for describing a positional relationship between the valve member and a housing-side seal member.

FIG. 17 is a schematic diagram for describing the manufacturing method of the valve device according to the first embodiment and serves as a schematic diagram for indicating movement of the tubular body in response to an action indicated in FIG. 16.

FIG. 18 is a schematic diagram for describing a seat thrust direction of the housing-side seal member of the valve device according to the first embodiment.

FIG. 19 is a cross-sectional view of the valve device for describing the manufacturing method of the valve device according to the first embodiment and serves as a cross-sectional view for describing a next step following the step of FIG. 15.

FIG. 20 is a schematic diagram for describing the manufacturing method of the valve device according to the first embodiment.

FIG. 21 is a schematic diagram for describing the manufacturing method of the valve device according to the first embodiment and serves as a schematic diagram for describing a next step following the step of FIG. 20.

FIG. 22 is a schematic diagram for describing the manufacturing method of the valve device according to the first embodiment and serves as a schematic diagram for describing a next step following the step of FIG. 21.

FIG. 23 is a schematic diagram for describing the manufacturing method of the valve device according to the first embodiment and serves as a schematic diagram for describing a next step following the step of FIG. 22.

FIG. 24 is a schematic diagram for describing the manufacturing method of the valve device according to the first embodiment and serves as a schematic diagram for describing a next step following the step of FIG. 23.

FIG. 25 is a schematic diagram for describing the manufacturing method of the valve device according to the first embodiment and serves as a schematic diagram for describing a next step following the step of FIG. 24.

FIG. 26 is a schematic diagram for describing the manufacturing method of the valve device according to the first embodiment and serves as a schematic diagram for describing a next step following the step of FIG. 25.

FIG. 27 is a cross-sectional view of a valve device according to a second embodiment.

FIG. 28 is a cross-sectional view taken along line XXVIII-XXVIII in FIG. 27 and serves as a schematic diagram for describing a positional relationship between a limiter portion and a contact portion.

FIG. 29 is a partial cross-sectional view of the valve device according to the second embodiment and serves as a schematic diagram for describing a positional relationship between the limiter portion and the contact portion in a state that is different from the state of FIG. 28.

FIG. 30 is a cross-sectional view of a valve device according to a third embodiment.

FIG. 31 is an exploded perspective view for describing a relationship between a valve member and a tubular body of a valve device according to a fourth embodiment.

FIG. 32 is a cross-sectional view of a tubular body of a valve device according to the fifth embodiment.

FIG. 33 is a cross-sectional view of a valve device according to a sixth embodiment.

FIG. 34 is a partial cross-sectional view of a valve device according to a seventh embodiment.

### DETAILED DESCRIPTION

Previously, there is known a valve device that is placed in a flow passage for conducting fluid, and the valve device is configured to control flow of the fluid. The valve device includes: a valve housing, which has a flow passage; and a valve member, which is rotatable in an inside of the valve housing. In the valve device, the valve member includes a seal portion that blocks the flow passage when the seal portion contacts an edge portion of the valve housing that forms an opening of the flow passage.

For example, there has been proposed one such a valve device that includes a valve housing and a flap valve element. The valve housing has a valve chamber and a plurality of openings while each of the openings communicates between the valve chamber and a corresponding one of a plurality of flow passages. The flap valve element includes: a rotatable shaft, which is rotatably supported by the valve housing; and a seal portion that is rotatably received in the valve chamber and is configured to open and close the openings of the valve housing.

However, in the valve device described above, the seal portion also functions as a stopper that limits the rotation of the valve member. Therefore, an excess stress is applied to the seal portion every time when the valve member is rotated in a predetermined direction. As a result, when a damage, such as chipping or cracking, occurs at the seal portion, sealing performance of the seal portion may possibly be deteriorated.

A valve device of the present disclosure includes a valve housing, a valve member, a limiter portion and a contact portion.

The valve housing includes: a plurality of flow passages, through which fluid is flowable; a communication space, through which the plurality of flow passages is communicated relative to each other; and a valve-housing-side seal portion that is placed around an opening, which communicates between one of the plurality of flow passages and the communication space.

The valve member is shaped into a tubular form or a spherical form and is rotatable relative to the valve housing. The valve member includes a valve-member-side seal portion that blocks communication between the one of the plurality of flow passages and the communication space when the valve-member-side seal portion contacts the valve-housing-side seal portion.

The limiter portion is formed separately from the valve-housing-side seal portion and is immovable relative to the valve housing.

The contact portion is formed separately from the valve-member-side seal portion and is rotatable synchronously with rotation of the valve member relative to the valve housing. The contact portion is configured to limit rotation of the valve member relative to the valve housing when the contact portion contacts the limiter portion.

In the valve device of the present disclosure, the contact portion, which is configured to limit the rotation of the valve member relative to the valve housing upon contacting of the contact portion against the limiter portion, is formed separately from the valve-member-side seal portion. Furthermore, the limiter portion, against which the contact portion is contactable, is formed separately from the valve-housing-side seal portion. In this way, it is possible to limit application of stress to the valve-member-side seal portion and the valve-housing-side seal portion in response to collision of the contact portion against the limiter portion at the time of limiting the rotation of the valve member through the contact between the limiter portion and the contact portion. Thus, the valve device of the present disclosure can limit the deterioration of the valve-member-side seal portion and the valve-housing-side seal portion, and thereby the valve device can limit the deterioration of the sealing performance.

Hereinafter, various embodiments will be described with reference to the accompanying drawings. The following embodiments indicate specific examples of the present disclosure, and it should be understood that the present disclosure is not limited the following embodiments.

### First Embodiment

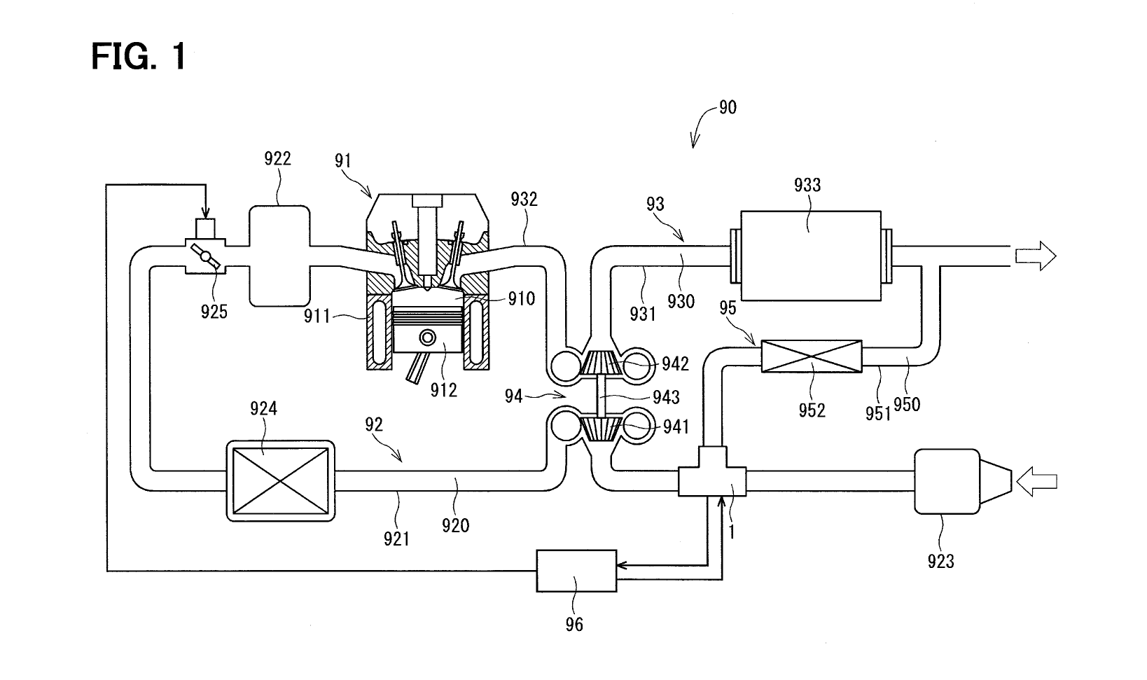

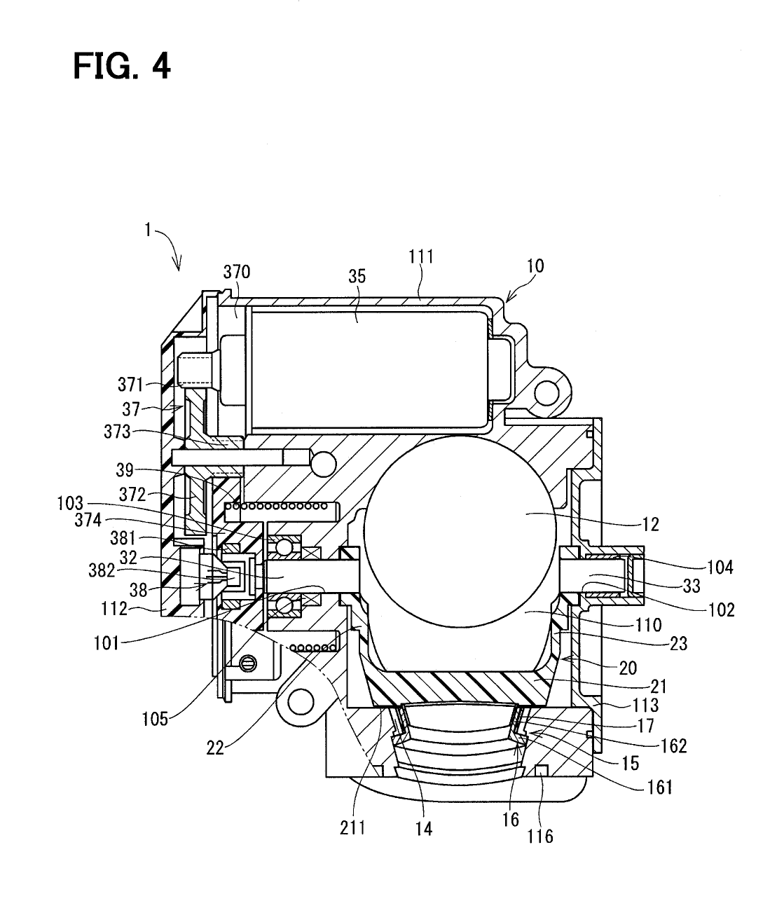

A valve device 1 according to a first embodiment will be described with reference to FIGS. 1 to 26. The valve device 1 is applied to an engine system 90 that generates a drive force by combusting fuel.

First of all, the engine system 90 will be described with reference to FIG. 1. The engine system 90 includes an engine 91, an air intake system 92, an exhaust system 93, a supercharger 94 and an exhaust gas recirculation system 95. The engine 91 has a well-known structure, in which a piston 912 is received in a cylinder 911 to form a combustion chamber 910.

The air intake system 92 supplies air from the surrounding atmosphere to the engine 91. The air intake system 92 includes an intake pipe 921, an intake manifold 922, an air cleaner 923, an intercooler 924 and a throttle valve 925. Hereinafter, the air, which is supplied to the engine 91, will be referred to as intake air.

The intake pipe 921 is a pipe that guides the intake air to the combustion chamber 910 and forms an intake passage 920. One end of the intake pipe 921 is opened to the surrounding atmosphere, and the other end of the intake pipe 921 is connected to the intake manifold 922.

The intake manifold 922 is connected to the other end of the intake pipe 921 and the engine 91. The intake manifold 922 has a structure of branching the passage to a plurality of passages, the number of which is the same as the number of the cylinders 911.

The air cleaner 923 removes foreign objects from the air taken from the surrounding atmosphere.

The intercooler 924 cools the intake air, the temperature of which is raised when the intake air is compressed by a compressor 941 of the supercharger 94.

The throttle valve 925 adjusts the amount of intake air fed to the engine 91. The throttle valve 925 is electrically connected to an electronic control unit (hereinafter referred to as an ECU) 96.

The exhaust system 93 releases the exhaust gas from the engine 91 to the surrounding atmosphere. The exhaust system 93 includes an exhaust pipe 931, an exhaust manifold 932 and an exhaust gas purification unit 933.

The exhaust pipe 931 is a pipe that guides the exhaust gas of the engine 91 to the surrounding atmosphere and forms an exhaust passage 930.

The exhaust manifold 932 is connected to one end of the exhaust pipe 931 and the engine 91. The exhaust manifold 932 has a structure of branching the passage to a plurality of passages, the number of which is the same as the number of the cylinders 911.

The exhaust gas purification unit 933 is installed to the exhaust pipe 931. The exhaust gas purification unit 933 decomposes hydrocarbons (HC) contained in the exhaust gas and captures particulate matter (PM).

The supercharger 94 supercharges the intake air to the combustion chamber 910 upon compressing the intake air in the intake pipe 921 through use of the energy of the exhaust gas. The supercharger 94 includes the compressor 941, a turbine 942 and a shaft 943.

The compressor 941 is placed between the air cleaner 923 and the intercooler 924 in the intake passage 920. The compressor 941 can compress the intake air.

The turbine 942 is placed between the exhaust manifold 932 and the exhaust gas purification unit 933 in the exhaust passage 930. The turbine 942 is rotated by the energy of the exhaust gas.

The shaft 943 couples between the compressor 941 and the turbine 942. The compressor 941 and the turbine 942 are rotated synchronously through the shaft 943.

The exhaust gas recirculation system 95 recirculates the exhaust gas, which has passed through the turbine 942, to the intake passage 920 to supply the recirculated exhaust gas to the combustion chamber 910 along with the air that has passed through the air cleaner 923. The exhaust gas recirculation system 95 includes an EGR pipe 951, an EGR cooler 952 and the valve device 1.

The EGR pipe 951 connects between a downstream side of the exhaust gas purification unit 933 in the exhaust pipe 931 and an upstream side of the compressor 941 in the intake pipe 921. The EGR pipe 951 has an EGR passage 950 that recirculates the exhaust gas, which has previously passed through the turbine 942, to the air, which is not yet compressed by the compressor 941.

The EGR cooler 952 is provided in the EGR pipe 951. The EGR cooler 952 cools the gas that passes through the EGR passage 950.

The valve device 1 is placed at a connection where the EGR pipe 951 and the intake pipe 921 are connected with each other. The valve device 1 increases or decreases a flow rate of the gas that is fed to the intake passage 920 through the EGR passage 950. The valve device 1 is electrically connected to the ECU 96.

The ECU 96 includes a microcomputer that has a CPU (serving as a processor), a RAM and a ROM (respectively serving as a storage device). The ECU 96 controls the throttle valve 925 and the valve device 1 based on an operational state of a vehicle having the engine system 90 and/or an operational state of a relevant device and a result of an operation of an operator who operates the vehicle and/or the relevant device.

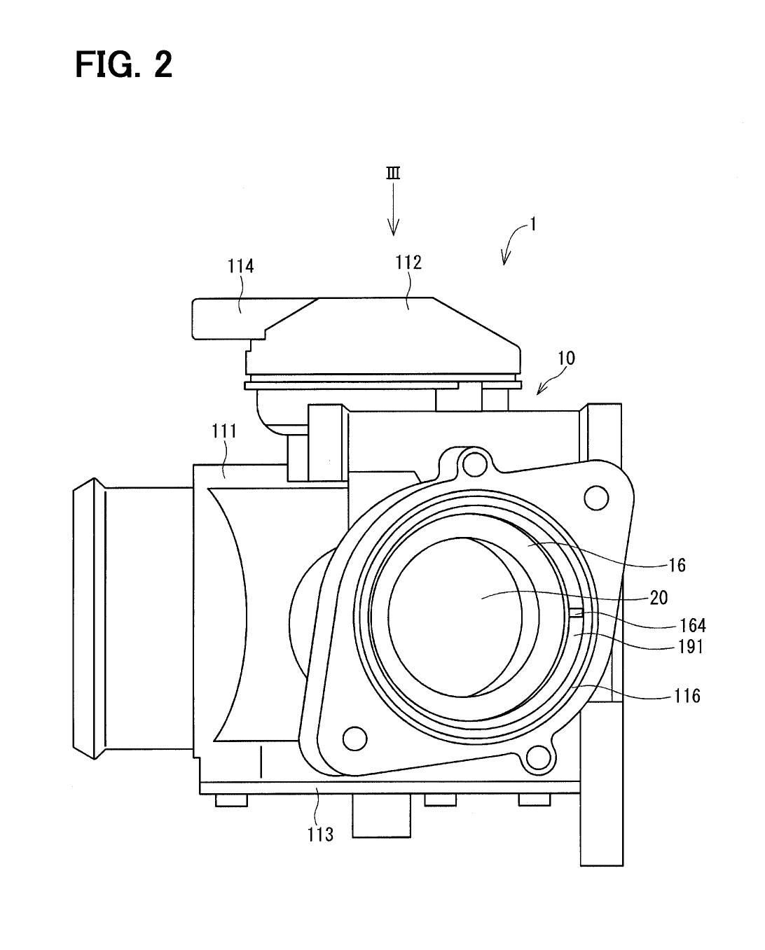

Next, details of the valve device 1 will be described with reference to FIGS. 2 to 11.

The valve device 1 is a rotary valve that can increase or decrease an opening degree of a passage of a fluid by rotating a valve member that is shaped into a cylindrical tubular form. The valve device 1 can increase or decrease an opening degree of the EGR passage 950 relative to the intake passage 920. The valve device 1 includes a valve housing 10, a valve member 20, a shaft 31, a drive device 35, a gear arrangement 37, a limiter portion 41 and a contact portion 42.

The valve housing 10 includes a casing 111, a sensor cover 112, a bottom cover 113, a tubular member (serving as a valve-housing-side seal portion) 16 and a housing-side seal member (serving as a valve-housing-side seal portion) 17.

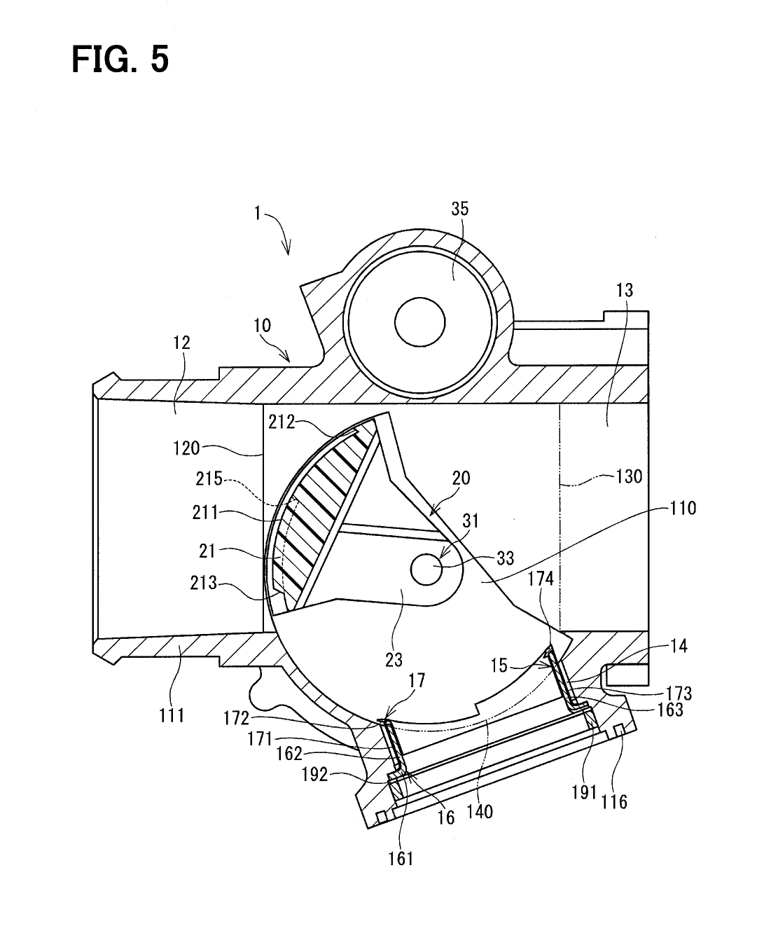

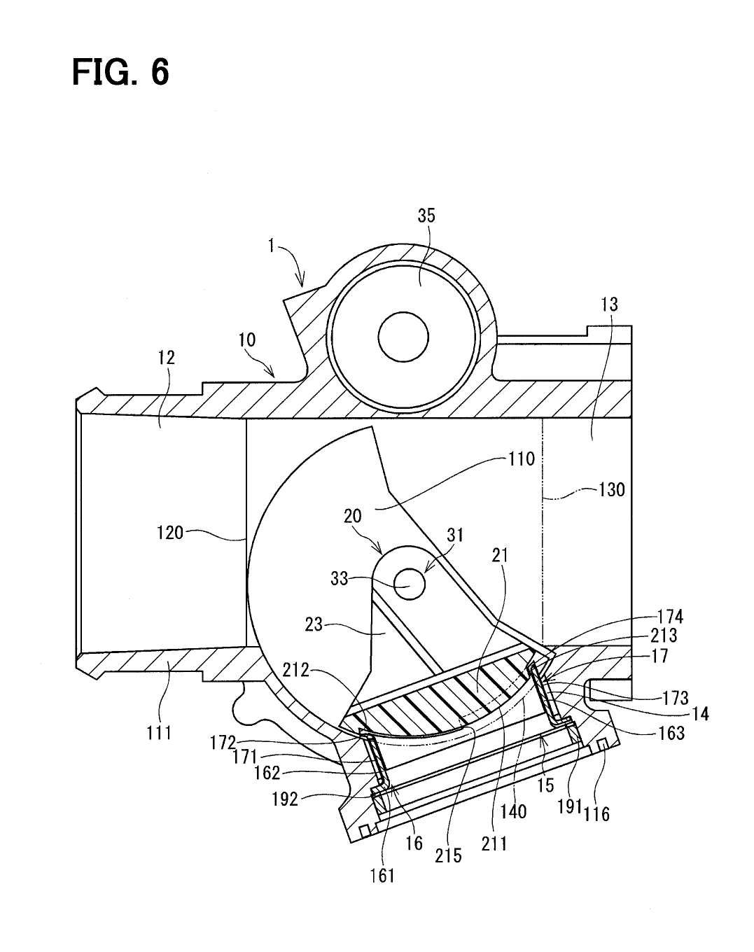

The casing 111 is made of a metal material, such as aluminum and is configured to receive the valve member 20. The casing 111 forms a merging portion where a flow of the intake passage 920 and a flow of the EGR passage 950 merge with each other. Specifically, as shown in FIGS. 5 and 6, the casing 111 includes a valve chamber (serving as a communication space) 110, an upstream-side flow passage (serving as a flow passage) 12, a downstream-side flow passage (serving as a flow passage) 13 and a receiving space (serving as a flow passage) 14.

The sensor cover 112 is placed at an end part of the casing 111 located on a side where a through-hole 101, which receives an upper shaft 32, is placed. The casing 111 and the sensor cover 112 form a receiving space 370 that is configured to receive the drive device 35, the gear arrangement 37 and the like.

The bottom cover 113 is placed on an opposite side of the casing 111 that is opposite from the side where the sensor cover 112 is placed. The bottom cover 113 cooperates with the casing 111 to form the valve chamber 110. The bottom cover 113 includes a through-hole 102, into which a lower shaft 33 described later is inserted.

The valve chamber 110 is substantially shaped into a cylindrical tubular form to rotatably receive the valve member 20.

The upstream-side flow passage 12 is formed to communicate with the valve chamber 110. The upstream-side flow passage 12 is communicated with the air cleaner 923.

The downstream-side flow passage 13 is formed to communicate with the valve chamber 110 independently from the upstream-side flow passage 12. The downstream-side flow passage 13 is formed to be coaxial with the upstream-side flow passage 12. The downstream-side flow passage 13 is communicated with the intercooler 924.

The receiving space 14 is formed to be communicated with the valve chamber 110 independently from the upstream-side flow passage 12 and the downstream-side flow passage 13. The receiving space 14 is formed to receive the tubular member 16, to which the housing-side seal member 17 is assembled. The receiving space 14 is communicated with the EGR passage 950.

The tubular member 16 is a member that is formed separately from the casing 111. The tubular member 16 includes a flange portion 161, a first side wall portion 162 and a second side wall portion 163. The tubular member 16 is made of stainless steel.

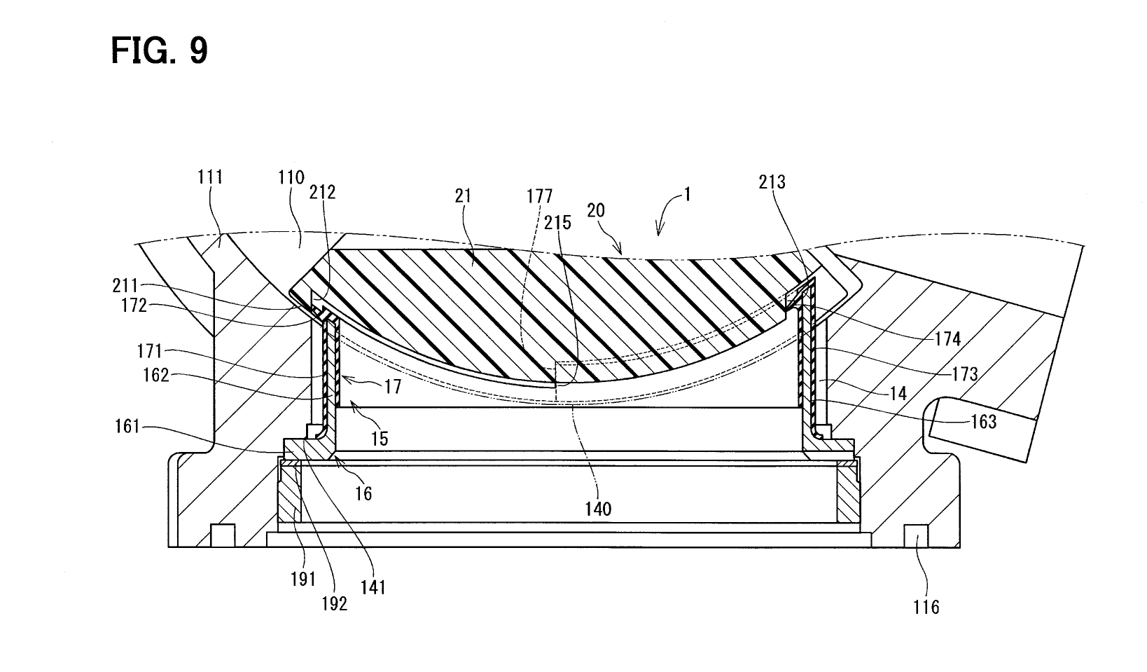

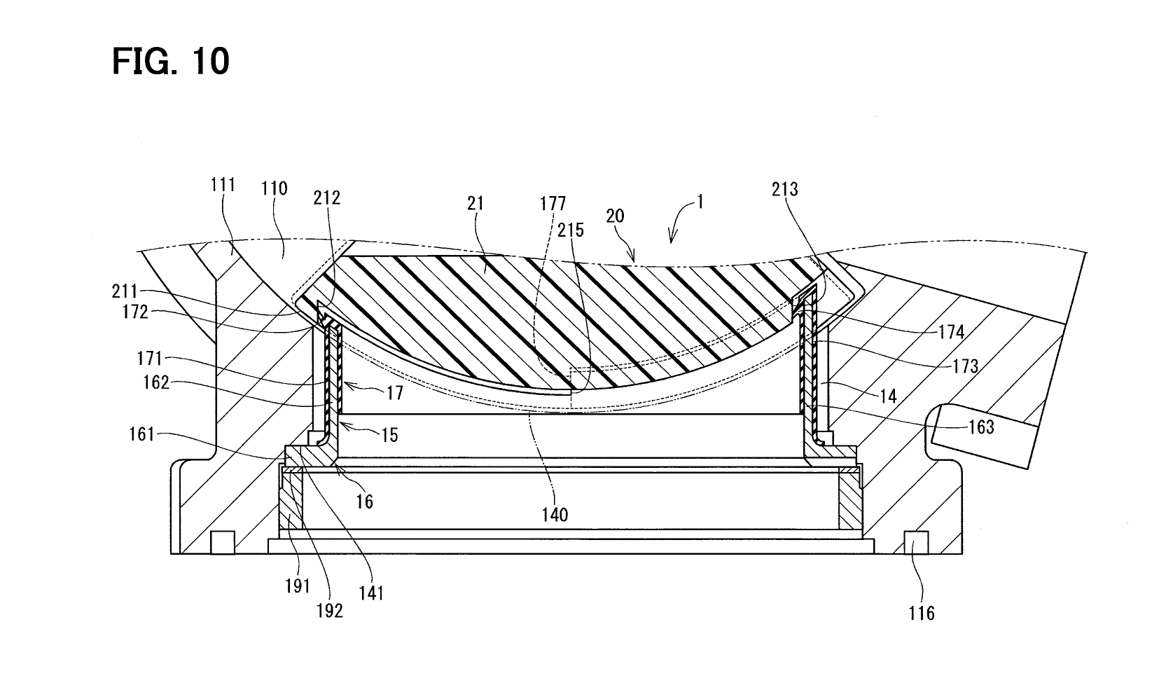

The flange portion 161 is a portion that is substantially shaped into a ring form. At the time of receiving the tubular member 16 into the receiving space 14, the flange portion 161 contacts a step surface 141 that is formed at an inner wall, which forms the receiving space 14 (see FIGS. 9 and 10). At this time, a ring (serving as a fixation member) 191, which is shaped into a ring form, is press fitted into the casing 111, so that the tubular member 16 is fixed to the casing 111. The ring 191 urges the flange portion 161 against the step surface 141 through a wave washer 192. A fixing method of the tubular member 16 through use of the ring 191 and the wave washer 192 will be described later.

The first side wall portion 162 and the second side wall portion 163 extend in an axial direction of the flange portion 161 from an end surface of the flange portion 161, which contacts the step surface 141. The first side wall portion 162 and the second side wall portion 163 are respectively formed to have a shape that is the same as a shape of a corresponding portion of a peripheral wall of a cylindrical tube. In the first embodiment, the first side wall portion 162 and the second side wall portion 163 are formed such that a central angle of each of the first side wall portion 162 and the second side wall portion 163 is 180 degrees. The first side wall portion 162 is formed such that a height of the first side wall portion 162, which is measured in the axial direction of the flange portion 161, is lower than a height of the second side wall portion 163, which is measured in the axial direction of the flange portion 161.

The housing-side seal member 17 includes a first cover portion 171, a first seal lip portion (serving as a lip portion) 172, a second cover portion 173 and a second seal lip portion (serving as a lip portion) 174. The housing-side seal member 17 is substantially shaped into a tubular form and is made of an elastic material, such rubber.

The first cover portion 171 is formed to cover: a radially inner side and a radially outer side of the first side wall portion 162; and an end part of the first side wall portion 162 while the end part of the first side wall portion 162 is opposite from the flange portion 161.

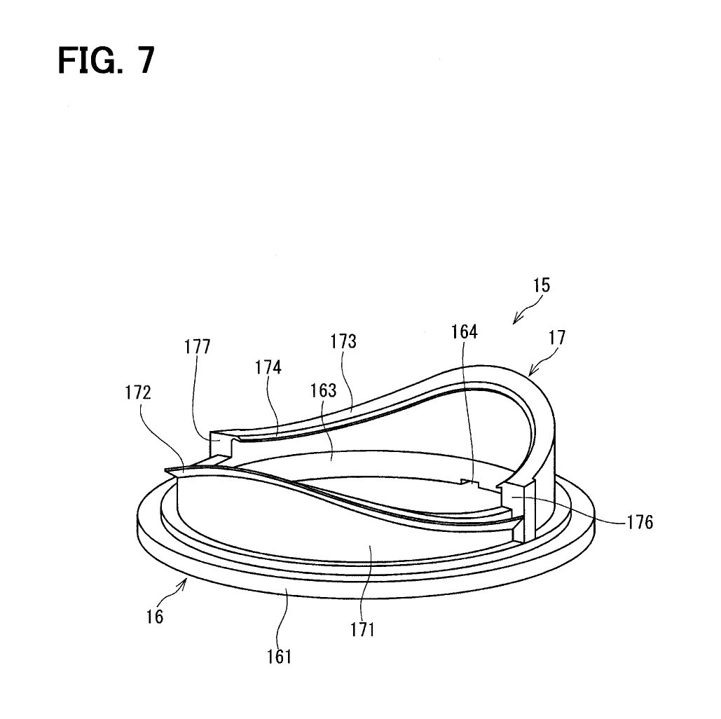

The first seal lip portion 172 is a portion that is shaped into a lip form and is placed at a location where the first seal lip portion 172 covers an opposite end part of the first cover portion 171, which is opposite from the flange portion 161. When the first cover portion 171 is formed to cover the first side wall portion 162, the first seal lip portion 172 is formed to project in a radially outward direction of the first side wall portion 162, i.e., a radially outward direction of the flange portion 161, as shown in FIG. 7.

The second cover portion 173 is formed to cover: a radially inner side and a radially outer side of the second side wall portion 163; and an end part of the second side wall portion 163 while the end part of the second side wall portion 163 is opposite from the flange portion 161. The second cover portion 173 also covers an end surface of each of two circumferentially opposite parts of the second side wall portion 163 that are respectively joined to the first side wall portion 162. The second cover portion 173 includes two seal surfaces (serving as valve-housing-side step surfaces) 176, 177. The seal surfaces 176, 177 respectively face in the circumferential direction of the housing-side seal member 17 and are placed at two locations where the second cover portion 173 coves end surfaces of the two parts of the second side wall portion 163, at which the second side wall portion 163 is joined to the first side wall portion 162, as shown in FIG. 7. The seal surfaces 176, 177 are joined to the first seal lip portion 172.

The second seal lip portion 174 is a portion that is shaped into a lip form and is placed at a location where the second seal lip portion 174 covers an opposite end part of the second cover portion 173, which is opposite from the flange portion 161. When the second cover portion 173 is formed to cover the second side wall portion 163, the second seal lip portion 174 is formed to project in a radially inward direction of the second side wall portion 163, i.e., a radially inward direction of the flange portion 161, as shown in FIG. 7. The second seal lip portion 174 is joined to the seal surfaces 176, 177.

Hereinafter, a member, which is formed by the housing-side seal member 17 and the tubular member 16 joined together, will be referred to as a tubular body 15.

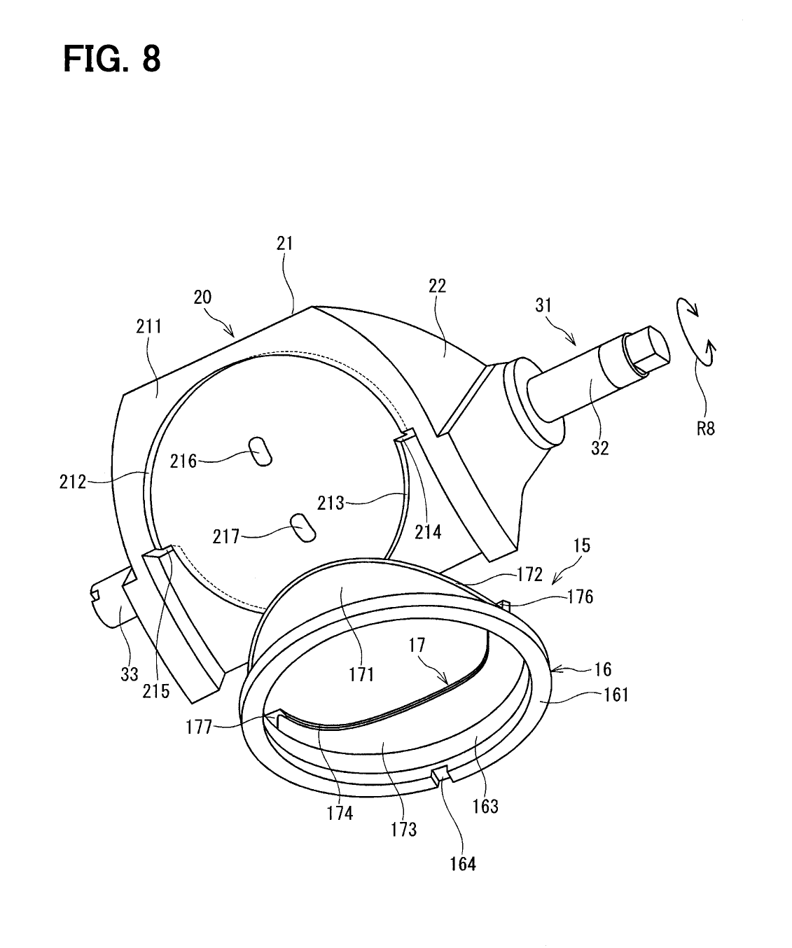

The valve member 20 includes a valve-member-side seal portion 21, an upper arm (serving as a support portion) 22 and a lower arm (serving as a support portion) 23. The valve member 20 is made of a resin material, such as polyphenylene sulfide, which has high heat resistance. The valve member 20 is received in the valve chamber 110 and is rotatable relative to the valve housing 10 (see a solid arrow R8 in FIG. 8). With respect to a rotational direction of the valve member 20, for the sake of convenience, a direction of rotating the valve member 20 from a state of FIG. 5 to a state of FIG. 6 will be referred to as an EGR passage closing direction, and a direction of rotating the valve member 20 from the state of FIG. 6 to the state of FIG. 5 will be referred to as an EGR passage opening direction.

The valve-member-side seal portion 21 is formed such that an outer wall surface (serving as a predetermined end surface) 211 of the valve-member-side seal portion 21, which can contact the housing-side seal member 17, has a shape that is the same as a shape of a portion of an outer peripheral wall surface of a cylindrical tube. As shown in FIGS. 8 to 10, the outer wall surface 211 includes two seal surfaces 212, 213 and two connection seal surfaces (serving as valve-member-side step surfaces) 214, 215.

The seal surfaces 212, 213 are formed in the outer wall surface 211 such that the seal surfaces 212, 213 extend in the circumferential direction of the valve-member-side seal portion 21.

The seal surface 212 is formed to extend toward a side in the EGR passage closing direction along the outer wall surface 211. The seal surface 212 is formed to have a shape that is the same as a shape of a portion of an inner wall surface of the outer peripheral wall of the cylindrical tube. In the first embodiment, the seal surface 212 is shaped into a semi-cylindrical form and has a central angle of 180 degrees. The seal surface 212 is formed such that a radius of the seal surface 212 is larger than a radius of the seal surface 213.

The seal surface 213 is formed to extend a side in the EGR passage closing direction along the outer wall surface 211. The seal surface 213 is formed to have a shape that is the same as a shape of a portion of an outer wall surface of the outer peripheral wall of the cylindrical tube. In the first embodiment, the seal surface 213 is shaped into a semi-cylindrical form and has a central angle of 180 degrees.

A central axis of an imaginary cylindrical surface, which includes the seal surface 212, and a central axis of an imaginary cylindrical surface, which includes the seal surface 213, are coaxial with each other. The central axis of these imaginary cylindrical surfaces is perpendicular to the rotational axis of the valve member 20.

The connection seal surfaces 214, 215 are formed in the outer wall surface 211 such that the connection seal surfaces 214, 215 face in the EGR passage closing direction. The connection seal surfaces 214, 215 are formed to be perpendicular to the seal surfaces 212, 213. When a normal line, which is normal to the connection seal surface 214, 215, is translated toward the rotational axis of the valve member 20, the normal line can be placed perpendicular to the rotational axis of the valve member 20.

The connection seal surface 214 is placed at one of two connections between the seal surface 212 and the seal surface 213, which is located on the upper arm 22 side.

The connection seal surface 215 is placed at the other one of the two connections between the seal surface 212 and the seal surface 213, which is located on the lower arm 23 side.

Each of the upper arm 22 and the lower arm 23 is formed as a portion that is substantially shaped into a fan form. The upper arm 22 and the lower arm 23 are respectively provided at two axial end parts of the valve-member-side seal portion 21.

The upper arm 22 is provided at one of the two axial end parts of the valve-member-side seal portion 21, which is located on a side where a drive device 35 described later is placed. The upper arm 22 is formed to extend from the corresponding axial end part of the valve-member-side seal portion 21, which is located on the drive device 35 side, toward the rotational axis of the valve member 20, i.e., the upper arm 22 is formed to extend from the corresponding axial end part of the valve-member-side seal portion 21 in a radial direction of the valve member 20.

The lower arm 23 is provided at the other one of the two axial end parts of the valve-member-side seal portion 21, which is located on an opposite side that is opposite from the drive device 35. The lower arm 23 is formed to extend in the radial direction of the valve member 20.

The outer wall surface 211 of the valve-member-side seal portion 21 of the valve member 20 can be reciprocated between an opening 120 of the upstream-side flow passage 12, which is located on the valve chamber 110 side, and an opening 140 of the receiving space 14, which is located on the valve chamber 110 side.

Specifically, when the valve member 20 is rotated in the EGR passage opening direction, an opening degree of the EGR passage 950, which is communicated with the receiving space 14, relative to the valve chamber 110 is maximized, while an opening degree of upstream-side flow passage 12 relative to the valve chamber 110 is minimized, as shown in FIG. 5. Furthermore, when the valve member 20 is rotated to place the valve-member-side seal portion 21 at its farthest position that is farthest in the EGR passage closing direction, the EGR passage 950 is fully closed relative to the valve chamber 110 while the upstream-side flow passage 12 is opened relative to the valve chamber 110 at a maximum opening degree, as shown in FIG. 6.

A contact state between the housing-side seal member 17 and the valve-member-side seal portion 21 at the time of fully closing the EGR passage 950 relative to the valve chamber 110 will be described with reference to FIGS. 9 and 10.

When the valve member 20 is rotated in the EGR passage closing direction from the state, in which the valve member 20 opens the EGR passage 950 at the maximum opening degree, the seal surfaces 212, 213 progressively approach the first seal lip portion 172 and the second seal lip portion 174, respectively, without contacting the first seal lip portion 172 and the second seal lip portion 174. At this time, the seal surfaces 176, 177 also progressively approach the connection seal surfaces 214, 215, respectively.

When the valve member 20 is further rotated in the EGR passage closing direction, the seal surfaces 212, 213 contact the first seal lip portion 172 and the second seal lip portion 174, respectively. When the valve member 20 is further rotated in the EGR passage closing direction, the first seal lip portion 172 and the second seal lip portion 174 are elastically deformed and are progressively bent. Specifically, the first seal lip portion 172 is pressed by the seal surface 212, so that the first seal lip portion 172 is elastically deformed and is progressively bent (see FIGS. 9 and 10). Also, the second seal lip portion 174 is pressed by the seal surface 213, so that the second seal lip portion 174 is elastically deformed and is progressively bent (see FIGS. 9 and 10). The connection seal surfaces 214, 215 respectively contact the seal surfaces 176, 177 and compress the second cover portion 173 in the circumferential direction of the housing-side seal member 17. In this way, the communication between the exhaust passage 930 and the valve chamber 110 is blocked.

As described above, in the valve device 1, the opening degree of the EGR passage 950 relative to the intake passage 920 and the opening degree of the intake passage 920 can be increased or decreased by rotating the valve member 20. In this way, the gas, which flows in the EGR passage 950, is drawn into the intake passage 920 by a negative pressure developed in the intake passage 920.

Furthermore, in the valve device 1, a state of the negative pressure in the valve chamber 110 can be also changed by changing the amount of air supplied into the valve chamber 110 by the way of changing the rotational angle of the valve member 20. In this way, the amount of exhaust gas supplied into the intake passage 920 can be changed. Specifically, the supply of the exhaust gas into the intake passage 920 on the upstream side of the compressor 941 can be also made by generating the negative pressure in the intake passage 920 through restriction of the flow of the air in the intake passage 920 with the valve member 20 instead of using the negative pressure generated by the engine 91.

The shaft 31 includes the upper shaft 32 and the lower shaft 33. Each of the upper shaft 32 and the lower shaft 33 is a member that is substantially shaped into a rod form and is made of stainless steel. The upper shaft 32 and the lower shaft 33 are arranged such that the rotational axis of the upper shaft 32 and the rotational axis of the lower shaft 33 are coaxial with each other.

The upper shaft 32 is installed to an opposite side of the upper arm 22 that is opposite from a side of the upper arm 22, which is joined to the valve-member-side seal portion 21. The upper shaft 32 is formed to extend in a direction away from the lower arm 23. The upper shaft 32 is inserted into the through-hole 101 of the casing 111. The upper shaft 32 is rotatably supported by a bearing 103 that is installed to an inner wall that forms the through-hole 101.

An oil seal 105 is installed to the upper shaft 32 at a location between the upper arm 22 and the bearing 103. The oil seal 105 limits intrusion of the gas of the valve chamber 110 into the receiving space 370.

The lower shaft 33 is installed to an opposite side of the lower arm 23 that is opposite from a side of the lower arm 23, which is joined to the valve-member-side seal portion 21. The lower shaft 33 is formed to extend in a direction away from the upper arm 22. The lower shaft 33 is inserted into the through-hole 102 of the bottom cover 113. The upper shaft 32 is rotatably supported by a bearing 104 that is installed to an inner wall that forms the through-hole 102.

The drive device 35 is, for example, a DC motor that has a sliding structure that includes brushes and a commutator. The drive device 35 is electrically connected to the ECU 96 through a connector 114 of the valve housing 10. The drive device 35 is controlled by the ECU 96 and thereby generates a torque that is capable of rotating the valve member 20.

The gear arrangement 37 includes a plurality of gears and transmits the torque of the drive device 35 to the upper shaft 32 upon amplifying the torque according to a speed reducing ratio of the gear arrangement 37. The gear arrangement 37 includes a pinion gear 371, an intermediate reduction gear 372, a small diameter gear 373 and a valve gear 374.

The pinion gear 371 is installed to an output shaft of the drive device 35.

The intermediate reduction gear 372 is meshed with the pinion gear 371.

The small diameter gear 373 and the intermediate reduction gear 372 are supported by a common center shaft and are rotated integrally.

The valve gear 374 is meshed with the small diameter gear 373. An outer diameter of the valve gear 374 is larger than, for example, an outer diameter of the upper shaft 32, and the valve gear 374 is rotated integrally with the upper shaft 32. A return spring 39, which urges the valve member 20 to rotate the valve member 20 in the EGR passage closing direction, is placed between the valve gear 374 and the casing 111.

The sensor device 38 includes a magnet 381 and a Hall IC 382.

The magnet 381 is fixed to the valve gear 374 and is rotated together with the shaft 31 and the valve gear 374.

The Hall IC 382 is installed to the sensor cover 112. The Hall IC 382 outputs an electric signal, which corresponds to a magnetic flux density of the magnetic field generated by the magnet 381, to the ECU 96 through the connector 114. The ECU 96 performs feedback control of the amount of electric power supply to the drive device 35 such that a rotational angle of the valve member 20, which is sensed with the sensor device 38, coincides with a target value. The target value of the rotational angle is set according to an operational state of the engine system 90.

The limiter portion 41 is placed in the receiving space 370. The limiter portion 41 includes a base 411 and a pin 412.

An inner wall of the casing 111, which forms the receiving space 370, is provided with the base 411 that is fixed to a portion of the inner wall of the casing 111, which is adjacent to the valve gear 374.

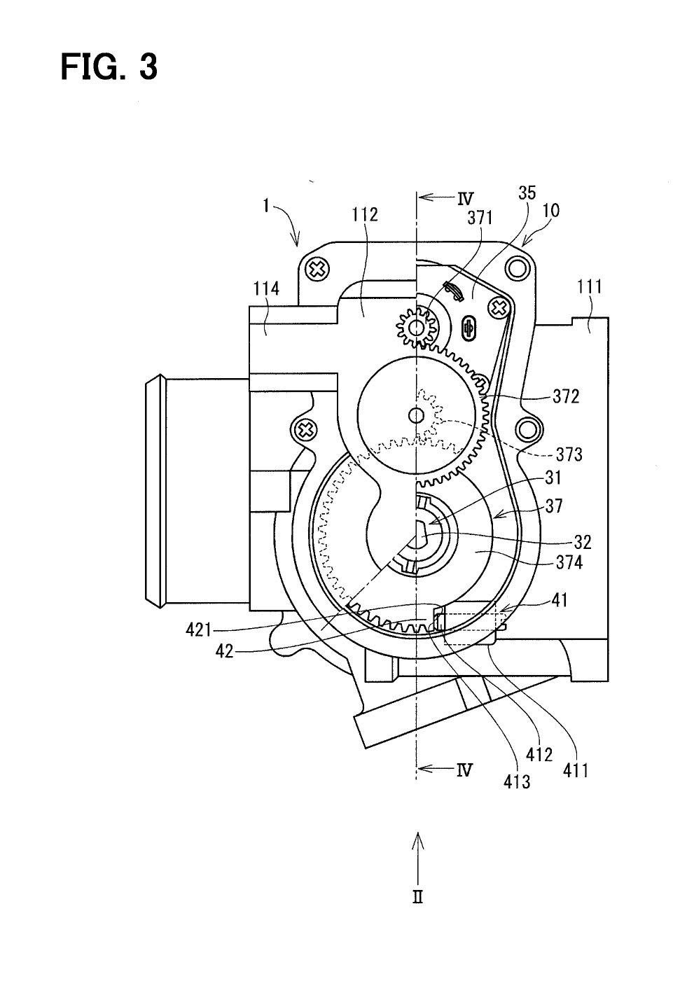

The pin 412 is threadably engaged with and is thereby secured to the base 411. As shown in FIG. 3, an end portion of the pin 412 projects from the base 411.

The contact portion 42 is provided at the valve gear 374. Specifically, as shown in FIG. 3, the contact portion 42 is formed at a corresponding part of a radially outer end portion (outer peripheral portion) of the valve gear 374 where the teeth of the valve gear 374 to be meshed with the small diameter gear 373 are not formed. A circumferential end surface 421 of the contact portion 42 contacts an end surface 413 of the projected end portion of the pin 412 when the valve member 20 is rotated by a predetermined angle in the EGR passage closing direction. Here, the predetermined angle refers to a rotational angle of the valve gear 374 in the state where the first seal lip portion 172 and the second seal lip portion 174 are elastically deformed.

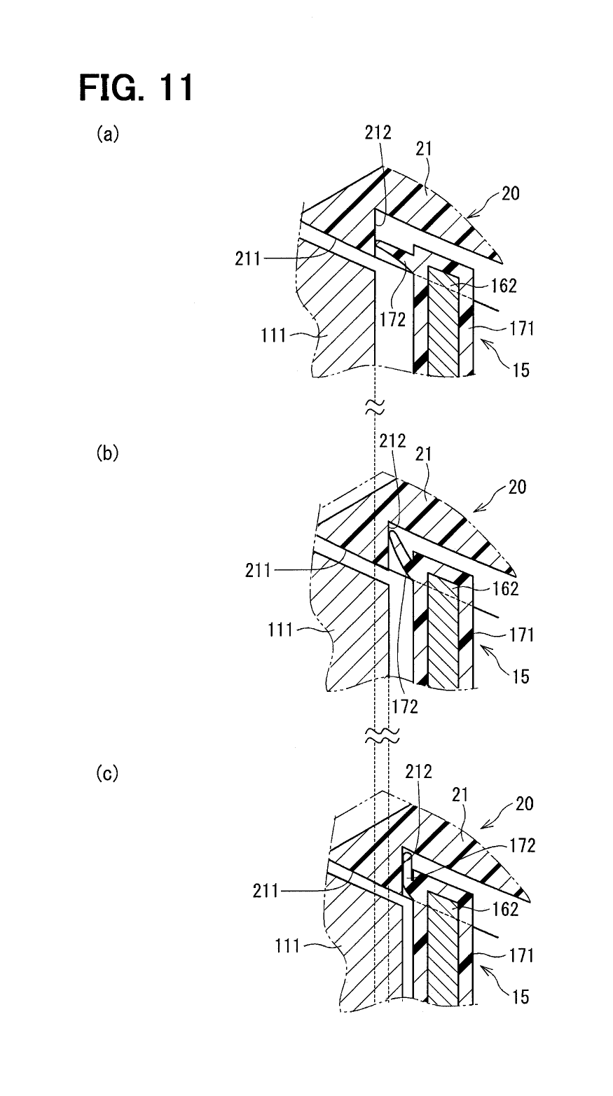

Here, the predetermined angle, at which the end surface 413 of the pin 412 and the end surface 421 of the contact portion 42 contact with each other, will be described with reference to the schematic diagram of (a) to (c) of FIG. 11, which show various degrees of deformation of the first seal lip portion 172.

In the valve device 1, when a positional relationship between the housing-side seal member 17 and the valve-member-side seal portion 21 is in an intermediate range between a start position P1 and a limit position P2, which respectively indicate rotational angles of the valve member 20, the rotational angle of the valve member 20 becomes the predetermined angle, and thereby the limiter portion 41 and the contact portion 42 contact with each other, so that the rotation of the valve member 20 is limited.

Here, the start position P1 is the rotational angle, at which the valve-member-side seal portion 21 of the valve member 20, which is rotated in the EGR passage closing direction, contacts the housing-side seal member 17. More specifically, the start position P1 is the rotational angle, at which the seal surface 212 contacts the first seal lip portion 172 (see (a) of FIG. 11), and the seal surface 213 contacts the second seal lip portion 174.

The limit position P2 is the rotational angle, at which the valve member 20 and the housing-side seal member 17 cannot be further deformed even if the valve member 20 is further rotated in the EGR passage closing direction in an imaginary state where the limiter portion 41 and the contact portion 42 are absent. More specifically, the limit position P2 is the rotational angle, at which the first seal lip portion 172 is held in a state (see (c) of FIG. 11) where the first seal lip portion 172 cannot be further deformed after the seal surface 212 urges and bends the first seal lip portion 172, and the second seal lip portion 174 is held in a state where the second seal lip portion 174 cannot be further deformed after the seal surface 213 urges and bends the second seal lip portion 174.

The intermediate range is a rotational angle range of the valve member 20 between the start position P1 and the limit position P2 while the start position P1 and the limit position P2 serve as limit values of this range. In the valve device 1, as shown in (b) of FIG. 11, in the intermediate range, the first seal lip portion 172 and the second seal lip portion 174 are respectively placed in a state where the elastic deformation of the first seal lip portion 172 and the elastic deformation of the second seal lip portion 174 are in progress. In the valve device 1, in the state shown in (b) of FIG. 11, the limiter portion 41 and the contact portion 42 contact with each other, and the rotation of the valve member 20 in the EGR passage closing direction is limited.

Next, positioning of the valve member 20 and the tubular body 15 at the valve device 1 will be described in view of a plurality of methods.

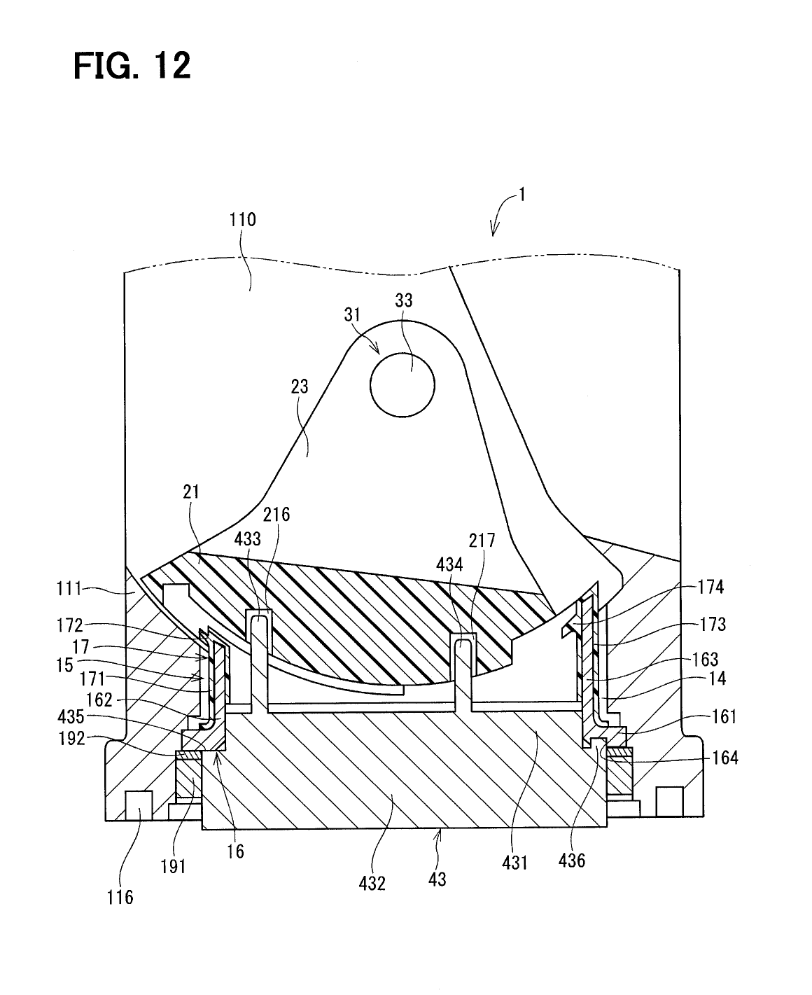

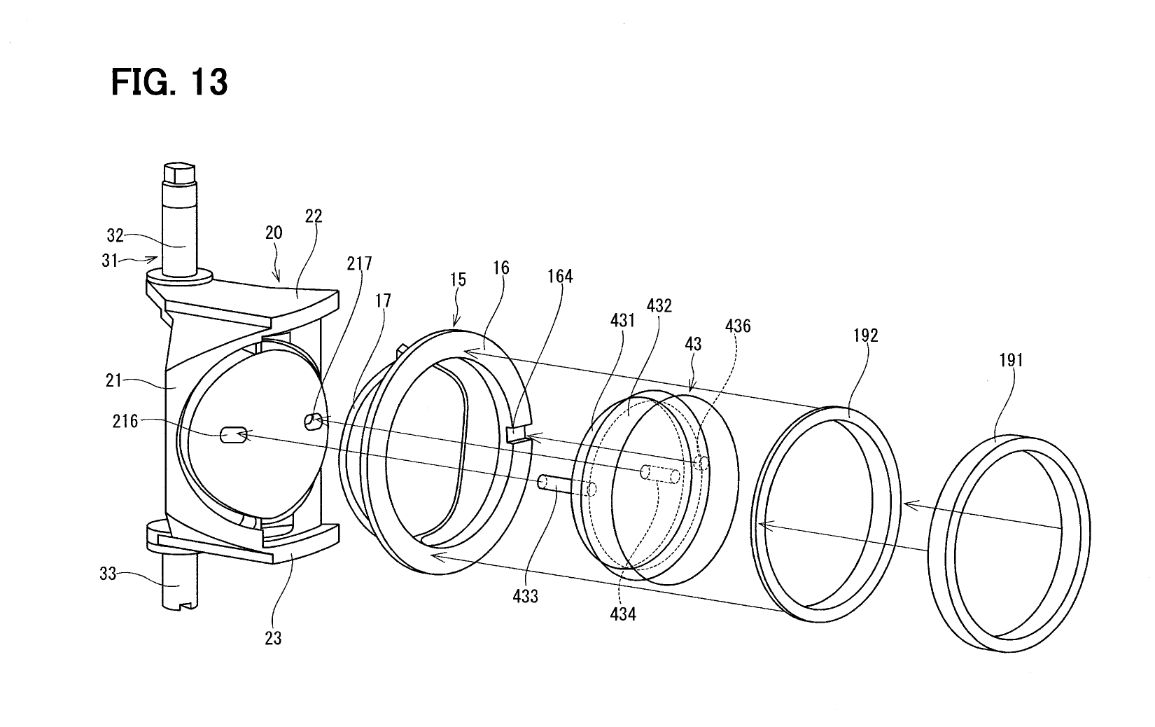

In the first manufacturing method, a positioning jig 43, which is shown in FIGS. 12 and 13 and is shaped into a cylindrical form, is used. The positioning jig 43 includes a distal end portion 431 and a proximal end portion 432.

The distal end portion 431 is formed such that an outer diameter of the distal end portion 431 is the same as an inner diameter of the tubular member 16. Thereby, the distal end portion 431 can be fitted into an inside of the tubular member 16. Two pins 433, 434, which can be fitted into two holes 216, 217 of the valve member 20, are provided at a distal end surface of the distal end portion 431.

An outer diameter of the proximal end portion 432 is larger than an outer diameter of the distal end portion 431. Thereby, the proximal end portion 432 has a step surface 435 that is located on the distal end portion 431 side and is contactable with the flange portion 161 of the tubular member 16. A pin 436, which is fitted into a groove 164 of the flange portion 161, is provided at the step surface 435.

In the first manufacturing method, at the time of receiving the tubular member 16 into the receiving space 14, the distal end portion 431 is fitted to an inner peripheral portion of the tubular member 16. At this time, as the positioning step, the pins 433, 434, 436 are respectively fitted into the holes 216, 217 and the groove 164, so that the tubular body 15 is positioned relative to the valve member 20. In this state, as shown in FIG. 13, the ring 191 is press fitted into the casing 111 together with the wave washer 192, so that the tubular member 16 is fixed to the casing 111.

In the second manufacturing method, the connection seal surfaces 214, 215 of the valve-member-side seal portion 21 are brought into contact with the seal surfaces 176, 177 of the housing-side seal member 17, so that the valve member 20 and the tubular body 15 are positioned relative to each other.

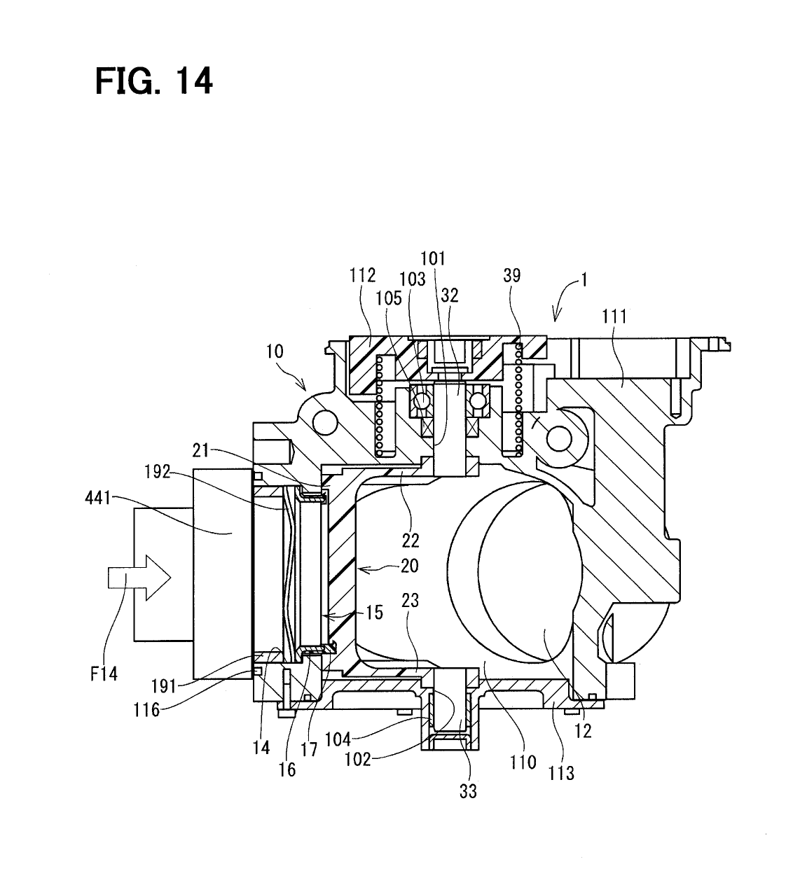

More specifically, first of all, the tubular body 15 is inserted into the receiving space 14. Next, as indicated by a blank arrow F14 in FIG. 14, as a provisional press fitting step, the ring 191 is pressed into the casing 111 through use of a first pushing jig 441 that has an outer diameter, which is larger than an inner diameter of the receiving space 14, so that the ring 191 is temporarily press fitted into the casing 111. At this time, the valve member 20 is placed in a position where the valve member 20 blocks the EGR passage 950.

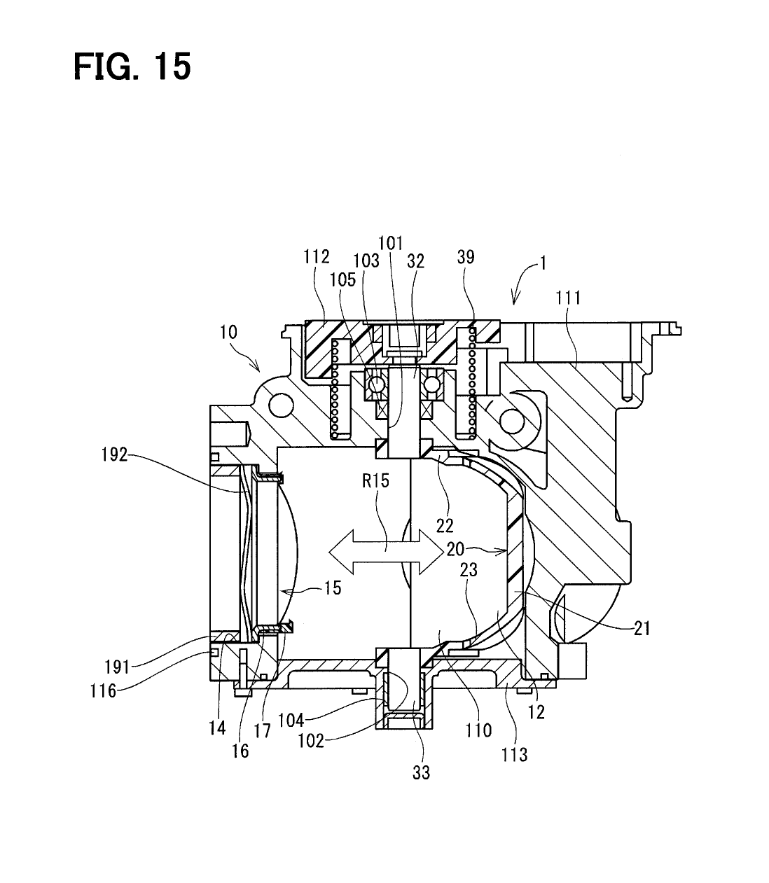

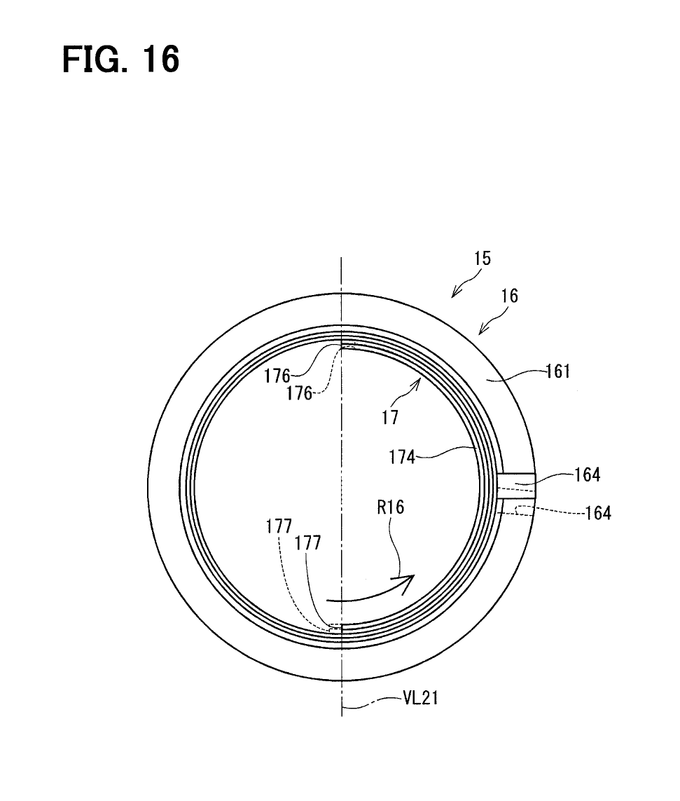

Next, the valve member 20 is rotated such that the upstream-side flow passage 12 is blocked by the valve member 20, and thereafter the valve member 20 is rotated such that the EGR passage 950 is blocked by the valve member 20 once again (see a blank arrow R15 in FIG. 15). At this time, in a case where the position of the tubular body 15 relative to the valve member 20 is held as indicated by a dotted line in FIG. 16, which indicates the position of the tubular body 15 at the time of viewing the valve chamber 110 from the receiving space 14, the tubular body 15 is not placed in a desirable position. Specifically, the seal surfaces 176, 177 are not placed along an imaginary line VL21 that is parallel with the rotational axis of the valve member 20 and connects between the connection seal surfaces 214, 215 of the valve-member-side seal portion 21.

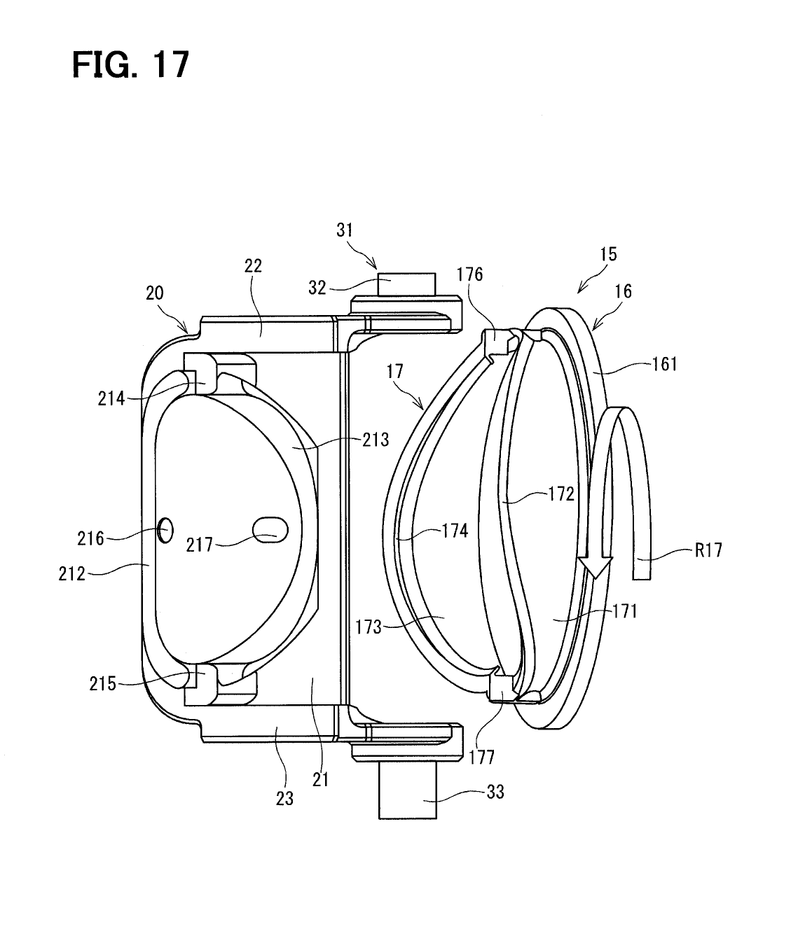

In view of the above point, in the second manufacturing method, as a positioning step, the tubular body 15 is rotated such that the seal surfaces 176, 177 overlap with the imaginary line VL21 in FIG. 16, as indicated by a solid arrow R16 in FIG. 16 and a blank arrow R17 in FIG. 17. At this time, the seal surfaces 176, 177 are respectively urged against the connection seal surfaces 214, 215, so that the position of the tubular body 15 relative to the valve member 20 is determined.

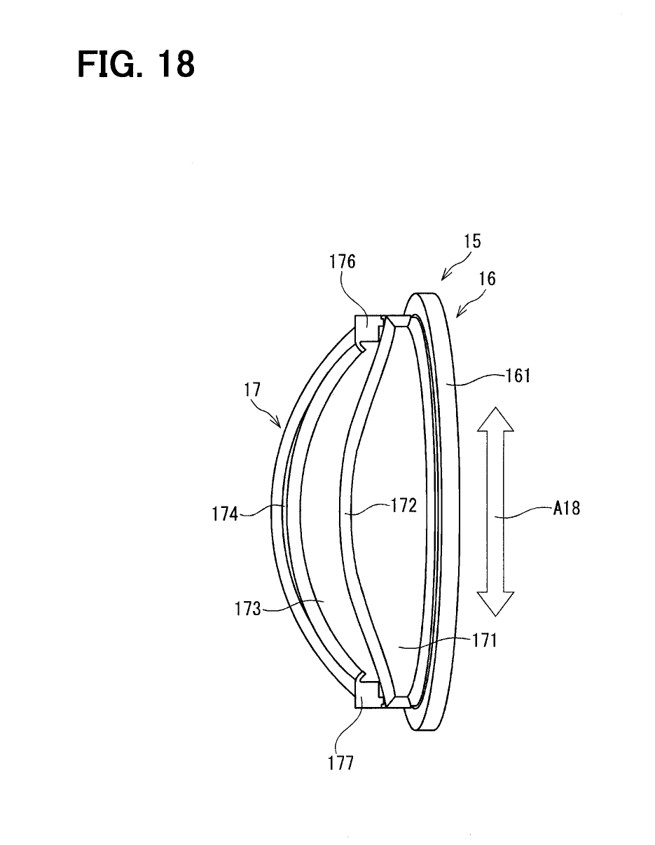

At this time, a position of the tubular body 15 relative to the valve member 20 in a seat thrust direction (a direction indicated by a blank arrow A18 in FIG. 18), which is parallel with the rotational axis of the valve member 20, is determined by the elastic force of the first seal lip portion 172 and the elastic force of the second seal lip portion 174.

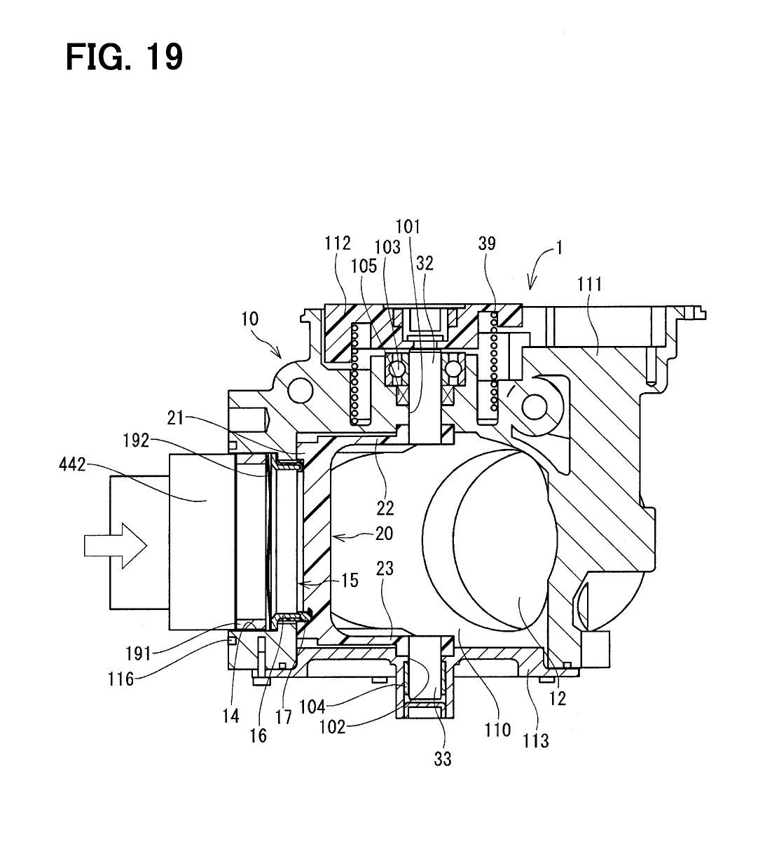

Finally, as shown in FIG. 19, the ring 191 is further pushed into the casing 111 to compress the wave washer 192 by a second pushing jig 442 that has an outer diameter, which is smaller than the inner diameter of the receiving space 14, so that the ring 191 is fixed to the casing 111.

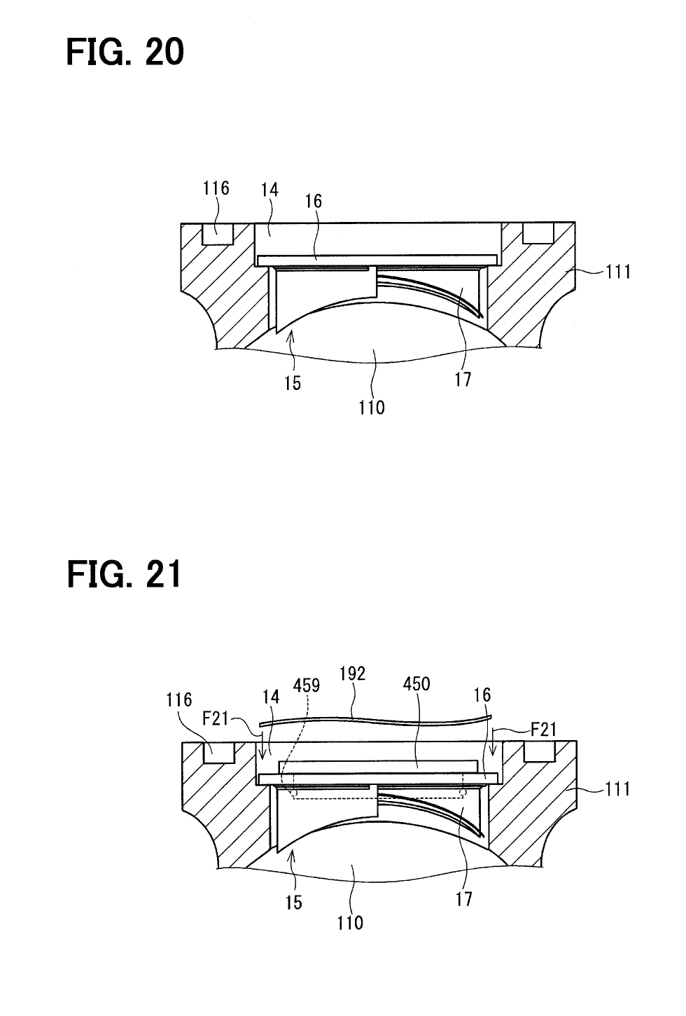

Furthermore, in the second manufacturing method, the tubular body 15 is positioned relative to the valve member 20 through use of a pushing jig 45 described below, and thereafter the ring 191 is fixed to the casing 111. This method will be described with reference to FIGS. 20 to 26.

First of all, as shown in FIG. 20, the tubular body 15 is inserted into the receiving space 14.

Next, with reference to FIG. 21, as a provisional fixing step, a weight jig 450 is inserted from an outside of the casing 111 into an inside of the tubular member 16, and the wave washer 192 is placed on an opposite side of the tubular member 16, which is opposite from the valve chamber 110 (see a solid arrow F21 in FIG. 21). In this way, the tubular body 15 is provisionally fixed to the casing 111. At this time, the weight jig 450 is fitted to the tubular member 16 through an O-ring 459.

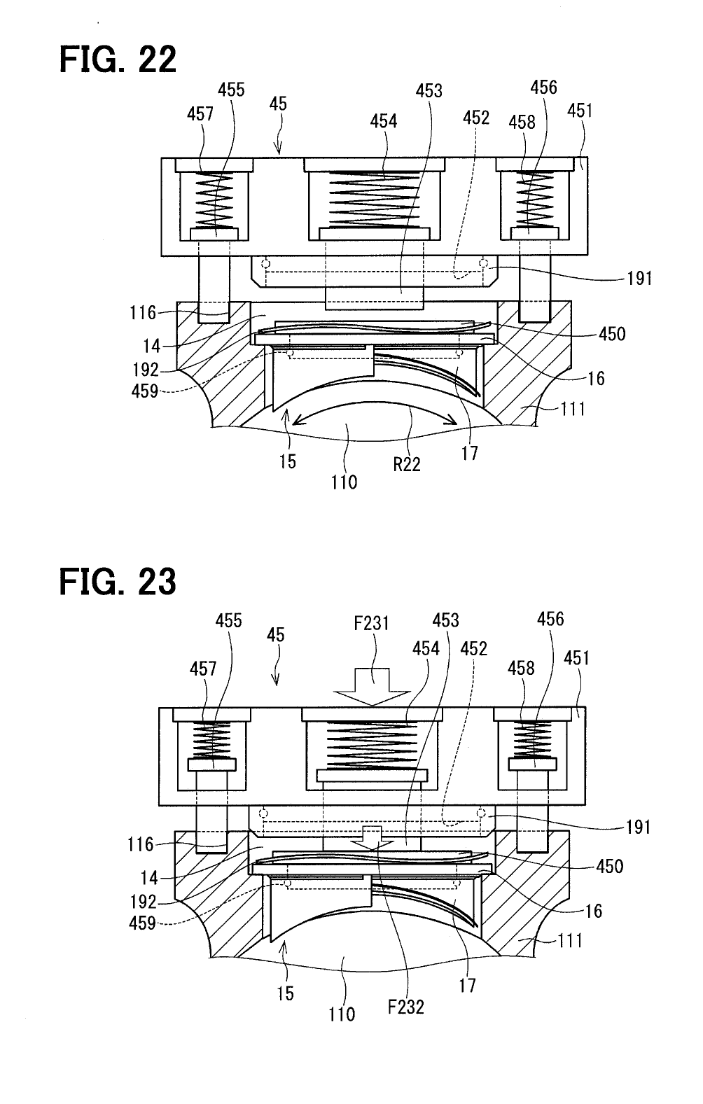

Next, as shown in FIG. 22, the ring 191 is set to the pushing jig 45.

Here, a structure of the pushing jig 45 will be described with reference to FIG. 22. The pushing jig 45 includes a main body portion 451, a ring support portion 452, a pressing pin 453, a pressing spring 454, positioning pins 455, 456 and positioning springs 457, 458.

The main body portion 451 is a housing that supports the ring support portion 452, the pressing pin 453, the pressing spring 454, the positioning pins 455, 456 and the positioning springs 457, 458.

The ring support portion 452 is a portion that is substantially shaped into a ring form and is placed at a side surface of the main body portion 451. The ring support portion 452 is formed such that an outer diameter of the ring support portion 452 is the same as an inner diameter of the ring 191. The ring 191 is detachably installable to the ring support portion 452 through, for example, an O-ring.

The pressing pin 453 is inserted through the ring support portion 452. The pressing pin 453 is configured to contact the weight jig 450.

The pressing spring 454 has an urging force that can urge the pressing pin 453. This urging force urges the pressing pin 453 against the weight jig 450.

The positioning pins 455, 456 are provided at symmetrical positions, which are symmetrical to each other with respect the pressing pin 453 interposed therebetween. Distal ends of the positioning pins 455, 456 are insertable into a groove 116 that is in a ring form and is formed at a peripheral portion of the casing 111, which forms the opening of the receiving space 14.

Each of the positioning springs 457, 458 has an urging force that can urge the corresponding one of the positioning pins 455, 456. This urging force urges the corresponding positioning pin 455, 456 in an inserting direction of the positioning pin 455, 456 into the groove 116. In this way, when the positioning pins 455, 456 are inserted into the groove 116, the position of the pushing jig 45 relative to the casing 111 is held within a predetermined range.

In FIG. 22, the ring 191 is set at the ring support portion 452 of the pushing jig 45. At this time, the positioning pins 455, 456 are inserted into the groove 116, and thereby the pushing jig 45 is positioned relative to the casing 111.

Next, as discussed above with reference to FIG. 16, the connection seal surfaces 214, 215 of the valve-member-side seal portion 21 are brought into contact with the seal surfaces 176, 177 of the housing-side seal member 17, so that the tubular body 15 is positioned relative to the valve member 20 (see a solid arrow R22 shown in FIG. 22). At this time, the weight of the tubular body 15 and the weight of the weight jig 450 are applied to the tubular body 15.

Next, as shown in FIG. 23, the weight jig 450 is urged against the tubular body 15 by the pressing pin 453 (see blank arrows F231, F232 in FIG. 23), so that the tubular body 15 is provisionally fixed to the casing 111.

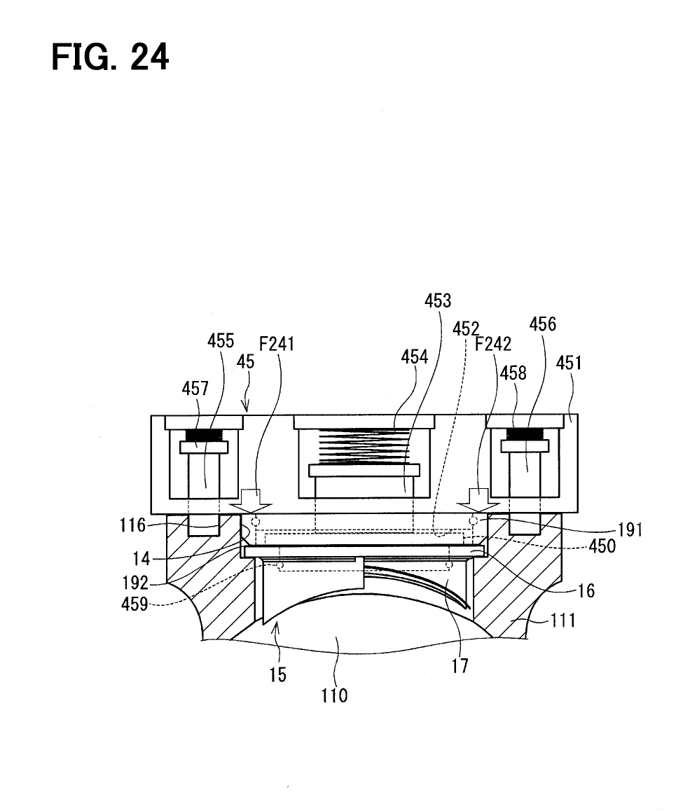

Next, as shown in FIG. 24, the ring 191 is press fitted into the casing 111 (see blank arrow F241, F242 in FIG. 24), and thereby the tubular body 15 is finally fixed to the casing 111 through the ring 191.

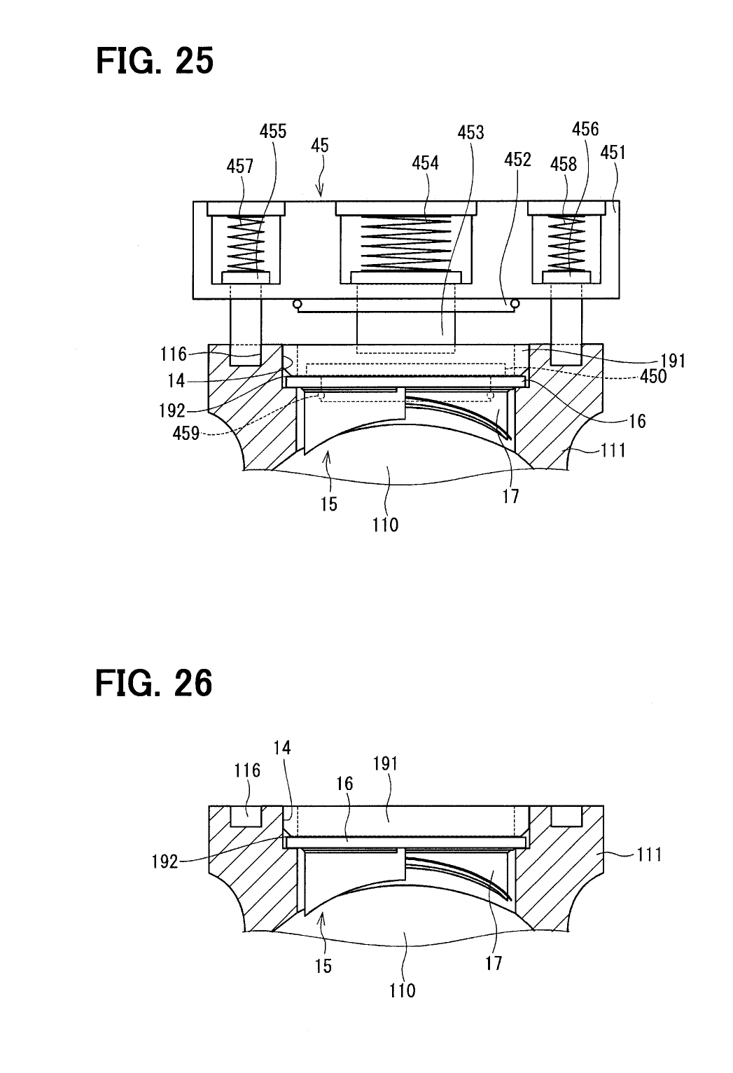

Then, as shown in FIG. 25, the pushing jig 45 is moved away from the casing 111, and thereby the ring 191 is spaced away from the pushing jig 45.

Finally, when the weight jig 450 is removed from the tubular body 15, the fixation of the tubular body 15 after the positioning of the tubular body 15 to the valve member 20 is completed, as shown in FIG. 26.

(a) In the valve device 1 of the first embodiment, the contact portion 42, which can limit the rotation of the valve member 20 relative to the valve housing 10 through the contact of the contact portion 42 against the pin 412 of the limiter portion 41, is formed separately from the housing-side seal member 17 and the valve-member-side seal portion 21. In this way, the rotation of the valve member 20 in the EGR passage closing direction is limited at the time of rotating the valve member 20, so that the application of the excess stress to the housing-side seal member 17 and the valve-member-side seal portion 21 can be limited. Thus, the valve device 1 can limit the deterioration of the housing-side seal member 17 and the valve-member-side seal portion 21, and thereby the valve device 1 can limit the deterioration of the sealing performance.

(b) In the valve device 1, the limiter portion 41 and the contact portion 42 are received in the receiving space 370, in which the gear arrangement 37 is received. Specifically, the limiter portion 41 and the contact portion 42 are placed at the outside of the valve chamber 110, the upstream-side flow passage 12, the downstream-side flow passage 13 and the EGR passage 950. Therefore, it is possible to limit an increase in a pressure loss of the gas, which flows in these spaces, by the limiter portion 41 and the contact portion 42.

Furthermore, since the limiter portion and the contact portion, which limit the rotation of the valve member 20, are not formed at the valve member 20, the structure of the valve member 20 can be simplified.

(c) In the valve device 1, the limiter portion 41 and the contact portion 42 are provided to the valve gear 374 that has a relatively large outer diameter. Therefore, the end surface 421 of the contact portion 42 can have a relatively large surface area, so that the strength of the contact portion 42 can be ensured, and the predetermined angle of the valve member 20 can be easily adjusted.

(d) Furthermore, in the limiter portion 41, the pin 412, which is contactable with the contact portion 42, is threadably engaged with and is thereby secured to the base 411. Therefore, the predetermined angle of the valve member 20 can be easily adjusted by increasing or decreasing a length of the projected part of the pin 412 that is projected from the base 411. Furthermore, the amount of deformation of the first seal lip portion 172 and the amount of deformation of the second seal lip portion 174 can be easily adjusted at the housing-side seal member 17.

(e) The housing-side seal member 17 is made of the rubber that has the elastic force. Thus, the sealing performance can be further improved.

Furthermore, the housing-side seal member 17 includes the first seal lip portion 172 and the second seal lip portion 174, which are respectively shaped into the lip form. Thus, the first seal lip portion 172 and the second seal lip portion 174 can be deformed and bent with a relatively small force, as shown in (b) of FIG. 11. Therefore, the communication between the valve chamber 110 and the EGR passage 950 can be reliably blocked. Furthermore, even when the second seal lip portion 174 is bent in an opposite direction, which is opposite from the flow direction of the gas in the EGR passage 950, the second seal lip portion 174 acts as a self-seal packing. Thus, the communication between the valve chamber 110 and the EGR passage 950 can be reliably blocked.

(f) In the valve device 1, the limiter portion 41 and the contact portion 42 contact with each other such that the rotation of the valve member 20 in the EGR passage closing direction is limited while the elastic deformation of the first seal lip portion 172 and the elastic deformation of the second seal lip portion 174 are in progress. In this way, in the valve device 1, the application of the excess stress to the housing-side seal member 17 can be reliably limited.

(g) In the first manufacturing method of the valve device 1 of the first embodiment, at the time of inserting the tubular body 15 into the receiving space 14, the pins 433, 434 of the positioning jig 43 are fitted into the holes 216, 217 of the valve member 20, and the pin 436 of the positioning jig 43 is fitted into the groove 164 of the flange portion 161. Thereby, the tubular body 15 is positioned relative to the valve member 20. In this way, the position of the tubular body 15 relative to the valve member 20 can be reliably set to the desirable position.

(h) In the second manufacturing method of the valve device 1 according to the first embodiment, the tubular body 15 is rotated such that the seal surfaces 176, 177 of the housing-side seal member 17 overlap with the imaginary line VL21, as shown in FIG. 16. In this way, the position of the tubular body 15 relative to the valve member 20 is determined.

Furthermore, in the second manufacturing method, when the tubular body 15 is rotated such that the seal surfaces 176, 177 of the housing-side seal member 17 overlap with the imaginary line VL21, the position of the tubular body 15 relative to the valve member 20 in the seat thrust direction, which is parallel with the rotational axis of the valve member 20, can be determined by the elastic force of the first seal lip portion 172 and the elastic force of the second seal lip portion 174.

As discussed above, in the second manufacturing method of the valve device 1, the position of the tubular body 15 relative to the valve member 20 can be reliably set to the desirable position without using any special jig.

(i) In the second manufacturing method of the valve device 1, as shown in FIGS. 20 to 26, the ring 191 is provisionally press fitted into the casing 111 through use of the pushing jig 45, and thereafter the seal surfaces 176, 177 of the housing-side seal member 17 are urged against the connection seal surfaces 214, 215 of the valve-member-side seal portion 21, so that the tubular body 15 is positioned relative to the valve member 20. Thereafter, as the final press fitting step, the ring 191 is finally press fitted into the casing 111 and is thereby fixed to the casing 111. In this way, the position of the tubular body 15 relative to the valve member 20 can be reliably set to the desirable position.

(j) In the second manufacturing method of the valve device 1, the ring 191 is provisionally press fitted into the casing 111 through use of the weight jig 450. In this way, variations in the load acting on the ring 191 can be limited, and thereby the provisional press fitting of the ring 191 can be maintained with a small load. Thus, even if the urging load of the valve member 20 is small, the adjustment of the seat is possible.

Furthermore, the wave washer 192 is placed between the tubular body 15 and the ring 191, and adjustment of the load applied to the wave washer 192 is relatively difficult. In the second manufacturing method, the load is applied to the entire wave washer 192, so that the ring 191 can be uniformly press fitted into the casing 111.

### Second Embodiment

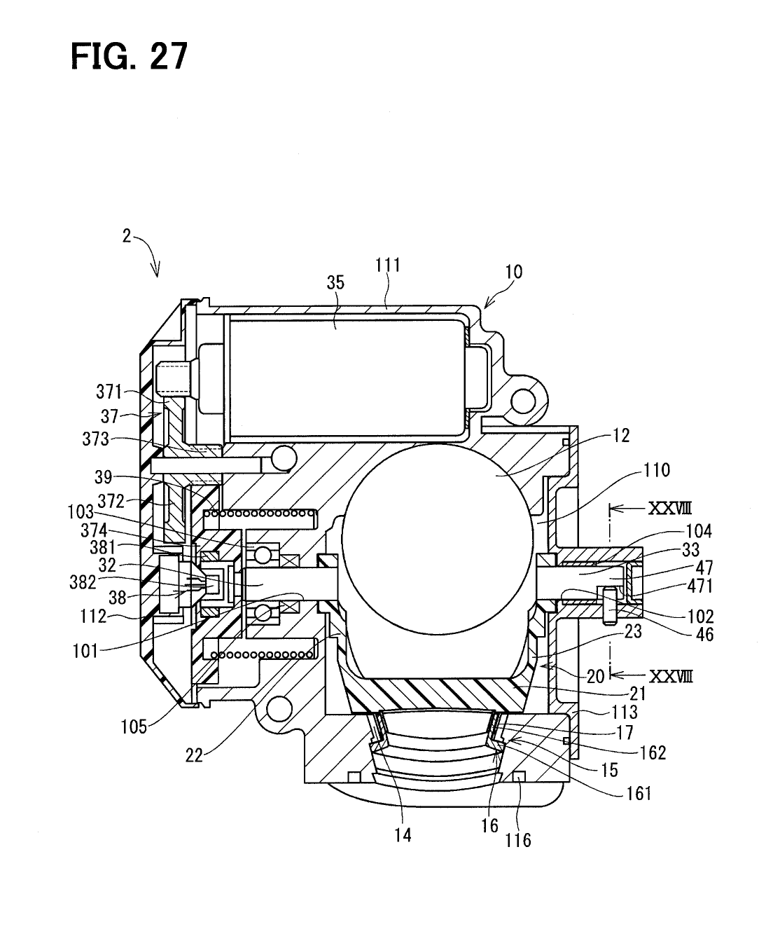

Next, a valve device of a second embodiment will be described with reference to FIGS. 27 to 29. The second embodiment differs from the first embodiment with respect to the locations of the limiter portion and the contact portion. Portions, which are substantially the same as those of the first embodiment, will be indicated by the same reference signs and will not be described redundantly for the sake of simplicity.

The valve device 2 of the second embodiment includes the valve housing 10, the valve member 20, the shaft 31, the drive device 35, the gear arrangement 37, a pin (serving as a limiter portion) 46 and a projection (serving as a contact portion) 47.

The pin 46 is a member that is substantially shaped into a rod form and is provided to an inner wall of the through-hole 102 of the bottom cover 113. As shown in FIG. 27, the pin 46 is arranged such that the pin 46 projects from the inner wall of the through-hole 102 in a radially inner direction of the through-hole 102. The pin 46 is threadably engaged with and is thereby secured to the inner wall of the through-hole 102.

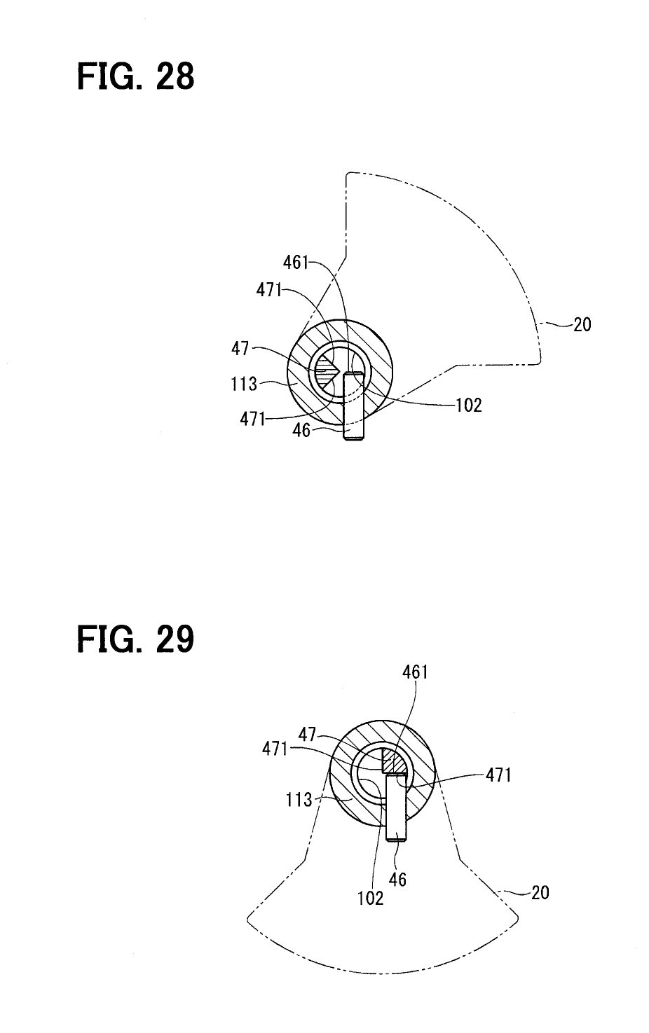

The projection 47 is provided to an end portion of the lower shaft 33, which is opposite from the side joined to the lower arm 23. The projection 47 is formed to extend from the end portion of the lower shaft 33 in an opposite direction that is opposite from the lower arm 23. A cross section of the projection 47, which is perpendicular to the rotational axis of the valve member 20, is in a form of a sector that has a central angle of 90 degrees, as shown in FIGS. 28 and 29, and the projection 47 has two end surfaces 471 that intersect perpendicular to each other.

A relationship between the pin 46 and the projection 47 in the valve device 2 will be described with reference to FIGS. 28 and 29. FIG. 28 is a schematic diagram indicating a relationship between the pin 46 and the projection 47 in a state where the EGR passage 950 is opened. FIG. 29 is a schematic diagram indicating a relationship between the pin 46 and the projection 47 in a state where the EGR passage 950 is blocked.

In the valve device 2 of the second embodiment, when the valve member 20 is rotated by a predetermined angle from the state shown in FIG. 28 in the EGR passage closing direction, the end surface 471 of the projection 47 contacts an end surface 461 of the pin 46, as shown in FIG. 29. In this way, the rotation of the valve member 20 in the EGR passage closing direction is limited.

As discussed above, in the valve device 2, the rotation of the valve member 20 in the EGR passage closing direction is limited through the contact between the pin 46 and the projection 47, which are provided separately from the housing-side seal member 17 and the valve-member-side seal portion 21. Thus, in the second embodiment, the advantages, which are the same as the advantages (a), (b) and (d) to (j) of the first embodiment, are achieved.

Furthermore, in the valve device 2, the pin 46 is placed at the location where the projecting length of the pin 46, which projects in the radially inward direction of the through-hole 102, can be adjusted even after the assembling of the valve device 2. In this way, the predetermined angle of the valve member 20, the amount of deformation of the first seal lip portion 172 and the amount of deformation of the second seal lip portion 174 can be easily and highly accurately adjusted.

### Third Embodiment

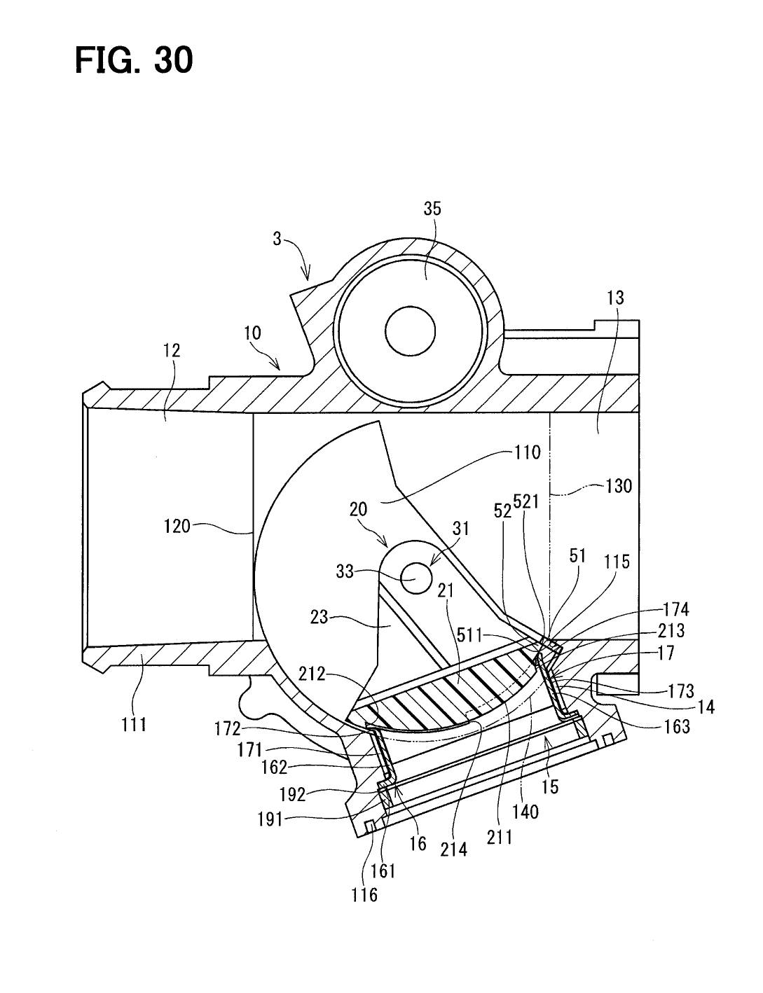

Next, a valve device of a third embodiment will be described with reference to FIG. 30. The third embodiment differs from the first embodiment with respect to the locations of the limiter portion and the contact portion. Portions, which are substantially the same as those of the first embodiment, will be indicated by the same reference signs and will not be described redundantly for the sake of simplicity.

The valve device 3 of the third embodiment includes the valve housing 10, the valve member 20, the shaft 31, the drive device 35, the gear arrangement 37, a projection (serving as a limiter portion) 51 and a contact portion 52.

The projection 51 is provided to the inner wall of the casing 111 that forms the valve chamber 110. Specifically, the projection 51 is provided to an inner wall 115 of the casing 111 that is located between the opening 140, which communicates between the valve chamber 110 and the receiving space 14, and an opening 130, which communicates between the downstream-side flow passage 13 and the valve chamber 110. The projection 51 is formed to project in a radially inward direction of the valve chamber 110.

The contact portion 52 is provided to an outer wall of the valve-member-side seal portion 21. Specifically, as shown in FIG. 30 that is a cross-sectional view indicating the valve member 20 that is viewed from the drive device 35 side, the contact portion 52 is provided to an end portion of the valve member 20, which is a leading side in the EGR passage closing direction that serves as a rotational direction. When the valve member 20 is rotated by the predetermined angle in the EGR passage closing direction, a radial end surface 521 of the contact portion 52 contacts the end surface 511 of the projection 51, which is located on the opening 140 side.

In the valve device 3 of the third embodiment, when the valve member 20 is rotated by the predetermined angle in the EGR passage closing direction from the state where the EGR passage 950 is opened, the end surface 521 of the contact portion 52 contacts the end surface 511 of the projection 51, as shown in FIG. 30. In this way, the rotation of the valve member 20 in the EGR passage closing direction is limited.

As discussed above, in the valve device 3, the rotation of the valve member 20 is limited through the contact between the projection 51 and the contact portion 52, which are provided separately from the housing-side seal member 17 and the valve-member-side seal portion 21. Thus, in the third embodiment, the advantages, which are the same as the advantages (a) and (e) to (j) of the first embodiment, are achieved.

In the valve device 3 of the third embodiment, the contact portion 52 is provided to the end portion of the valve member 20. Thus, in comparison to the case where the contact portion is provided to the valve gear 374 or the lower shaft 33, the structures of the valve gear 374 and the lower shaft 33 are simplified. Thus, the manufacturing costs of the valve device 3 can be reduced.

### Fourth Embodiment

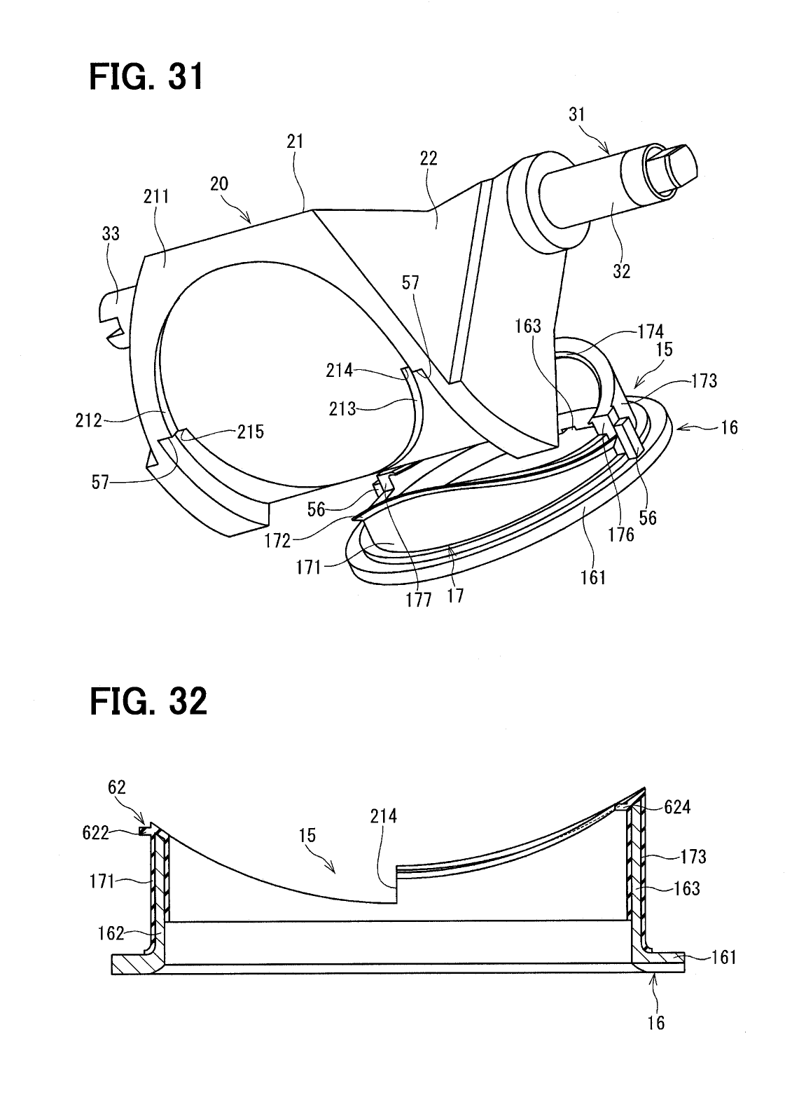

Next, a valve device of a fourth embodiment will be described with reference to FIG. 31. The fourth embodiment differs from the first embodiment with respect to the locations of the limiter portion and the contact portion. Portions, which are substantially the same as those of the first embodiment, will be indicated by the same reference signs and will not be described redundantly for the sake of simplicity.

The valve device of the fourth embodiment includes the valve housing 10, the valve member 20, the shaft 31, the drive device 35, the gear arrangement 37, a plurality of projections (respectively serving as a limiter portion) 56 and a plurality of contact portions 57.

The projections 56 are provided at the flange portion 161 of the tubular member 16. Specifically, as shown in FIG. 31, the projections 56 are formed such that the projections 56 extend in the axial direction of the flange portion 161 from an end surface of the flange portion 161, at which the first side wall portion 162 and the second side wall portion 163 are formed. In the fourth embodiment, the projections 56 are respectively provided adjacent to two connections, at which the first side wall portion 162 and the second side wall portion 163 are joined together. Specifically, in the fourth embodiment, the number of the projections 56 is two, and these two projections 56 are placed at the upper arm 22 side and the lower arm 23 side. Each of the projections 56 is substantially shaped into a column form that has a rectangular cross section.

The contact portions 57 are placed adjacent to the connection seal surfaces 214, 215, respectively, of the valve-member-side seal portion 21. Specifically, the contact portions 57 are respectively placed at the upper arm 22 side of the connection seal surface 214 and the lower arm 23 side of the connection seal surface 215. That is, in the fourth embodiment, the number of the contact portions 57 is two. At the outer wall surface 211, each of the contact portions 57 includes a contact surface that is formed to face in the EGR passage closing direction and is contactable with a corresponding one of the projections 56.

In the valve device of the fourth embodiment, when the valve member 20 is rotated by the predetermined angle in the EGR passage closing direction from the state where the EGR passage 950 is opened, the contact portions 57 respectively contact the projections 56. In this way, the rotation of the valve member 20 is limited.

As discussed above, in the valve device of the fourth embodiment, the rotation of the valve member 20 is limited through the contact between each projection 56 and the corresponding contact portion 57, which are provided at the corresponding locations that are different from the housing-side seal member 17 and the valve-member-side seal portion 21. Thus, in the fourth embodiment, the advantages, which are the same as the advantages (a), (b) and (e) to (j) of the first embodiment, are achieved.

Furthermore, in the valve device of the fourth embodiment, the amount of deformation of the first seal lip portion 172 and the amount of deformation of the second seal lip portion 174 can be determined by the positional relationship of the projections 56 relative to the first seal lip portion 172 and the second seal lip portion 174 while the projections 56 are placed adjacent to the first seal lip portion 172 and the second seal lip portion 174. In this way, with respect to the amount of deformation of the first seal lip portion 172 and the amount of deformation of the second seal lip portion 174, the influence of the variations of the component shape is reduced in comparison to the case where the contact portion is provided to the valve gear 374 or the lower shaft 33. Therefore, in the valve device of the fourth embodiment, the management of the amount of deformation of the first seal lip portion 172 and the amount of deformation of the second seal lip portion 174 can be easily carried out.

### Fifth Embodiment

Next, a valve device of a fifth embodiment will be described with reference to FIG. 32. In the fifth embodiment, the shape of the housing-side seal member differs from the shape of the housing-side seal member of the first embodiment. Portions, which are substantially the same as those of the first embodiment, will be indicated by the same reference signs and will not be described redundantly for the sake of simplicity.

The valve device of the fifth embodiment includes a valve housing 60, the valve member 20, the shaft 31, the drive device 35, the gear arrangement 37, the limiter portion 41 and the contact portion 42.

The valve housing 60 includes the casing 111, the sensor cover 112, the bottom cover 113, the tubular member 16 and a housing-side seal member (serving as a valve-housing-side seal portion) 62.

The housing-side seal member 62 includes the first cover portion 171, a first seal projection (serving as a projection) 622, the second cover portion 173 and a second seal projection (serving as a projection) 624. The housing-side seal member 62 is made of an elastic material, such as rubber.

The first seal projection 622 is a portion that is substantially shaped into a column form and is placed at a location where the first seal projection 622 covers an end portion of the first cover portion 171, which is opposite from the flange portion 161. When the first cover portion 171 is formed to cover the first side wall portion 162, the first seal projection 622 is formed to project in a radially outward direction of the first side wall portion 162, i.e., a radially outward direction of the flange portion 161, as shown in FIG. 32.

The second seal projection 624 is a portion that is substantially shaped into a column form and is placed at a location where the second seal projection 624 covers an end portion of the second cover portion 173, which is opposite from the flange portion 161. When the second cover portion 173 is formed to cover the second side wall portion 163, the second seal projection 624 is formed to project in a radially inward direction of the second side wall portion 163, i.e., a radially inward direction of the flange portion 161, as shown in FIG. 32.

In the valve device of the fifth embodiment, when the valve member 20 is rotated from the state where the EGR passage 950 is opened, the first seal projection 622 and the second seal projection 624 are respectively compressed and elastically deformed by the seal surfaces 212, 213 in an opposite direction that is opposite from the projecting direction thereof.

The valve device of the fifth embodiment includes the limiter portion 41 and the contact portion 42. Thus, the fifth embodiment achieves the advantages, which are the same as the advantages of the first embodiment.

Furthermore, at the time of blocking the EGR passage 950, each of the first seal projection 622 and the second seal projection 624 is compressed and elastically deformed by the corresponding seal surface 212, 213 in the opposite direction that is opposite from the projecting direction thereof. Therefore, the first seal projection 622 and the second seal projection 624 can ensure a higher surface pressure in comparison to the first seal lip portion 172 and the second seal lip portion 174 of the first embodiment. Thus, the fifth embodiment can improve the sealing performance.

Furthermore, the first seal projection 622 and the second seal projection 624 can improve the strength thereof in comparison to the lip form. Thereby, deterioration of the housing-side seal member 62 can be limited.

### Sixth Embodiment

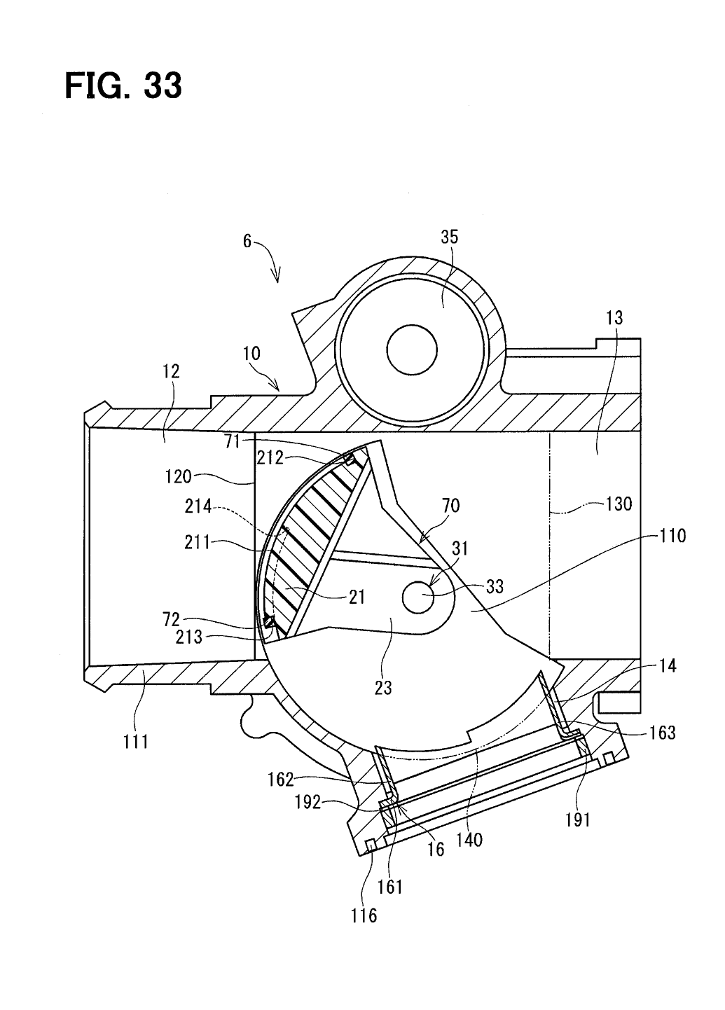

Next, a valve device of a sixth embodiment will be described with reference to FIG. 33. The sixth embodiment differs from the first embodiment with respect to provision of valve-member-side seal portions that are made of an elastic material and are formed at the valve member. Portions, which are substantially the same as those of the first embodiment, will be indicated by the same reference signs and will not be described redundantly for the sake of simplicity.

A valve device 6 of the sixth embodiment includes a valve housing 65, a valve member 70, two valve-member-side seal portions 71, 72, the shaft 31, the drive device 35, the gear arrangement 37, the limiter portion 41 and the contact portion 42.

The valve housing 65 includes the casing 111, the sensor cover 112, the bottom cover 113 and the tubular member 16. That is, in comparison to the first embodiment, the valve housing 65 does not have the housing-side seal member 17.

The valve member 70 includes the valve-member-side seal portion 21, the upper arm 22, the lower arm 23 and two valve-member-side seal portions 71, 72.

The valve-member-side seal portion 71 is shaped into a semicircular form and is made of an elastic material, such as rubber. The valve-member-side seal portion 71 is formed to contact the seal surface 212 while the valve-member-side seal portion 71 contacts the outer wall surface 211. The valve-member-side seal portion 71 is formed to be contactable with the first side wall portion 162 of the tubular member 16.

The valve-member-side seal portion 72 is shaped into a semicircular form and is made of an elastic material, such as rubber. The valve-member-side seal portion 72 is formed to contact the seal surface 213 while the valve-member-side seal portion 72 contacts the outer wall surface 211. The valve-member-side seal portion 72 is formed to be contactable with the second side wall portion 163 of the tubular member 16.

In the valve device 6 of the sixth embodiment, when the valve member 20 is rotated in the EGR passage closing direction from the state where the EGR passage 950 is opened, the valve-member-side seal portion 71 contacts the first side wall portion 162 of the tubular member 16, and the valve-member-side seal portion 72 contacts the second side wall portion 163 of the tubular member 16. In this way, the EGR passage 950 is blocked.

The valve device of the sixth embodiment includes the limiter portion 41 and the contact portion 42. Thus, the sixth embodiment achieves the advantages, which are the same as the advantages of the first embodiment.

Furthermore, in the valve device 6 of the sixth embodiment, in the state where the valve member 20 is rotated in the EGR passage opening direction and thereby opens the EGR passage 950, the valve-member-side seal portions 71, 72 are less likely exposed to the high temperature exhaust gas that flows in the EGR passage 950. In this way, the thermal deterioration of the valve-member-side seal portions 71, 72 made of the rubber can be limited. Thus, the valve device 6 of the sixth embodiment can reduce the secular change of the sealing performance.

### Seventh Embodiment

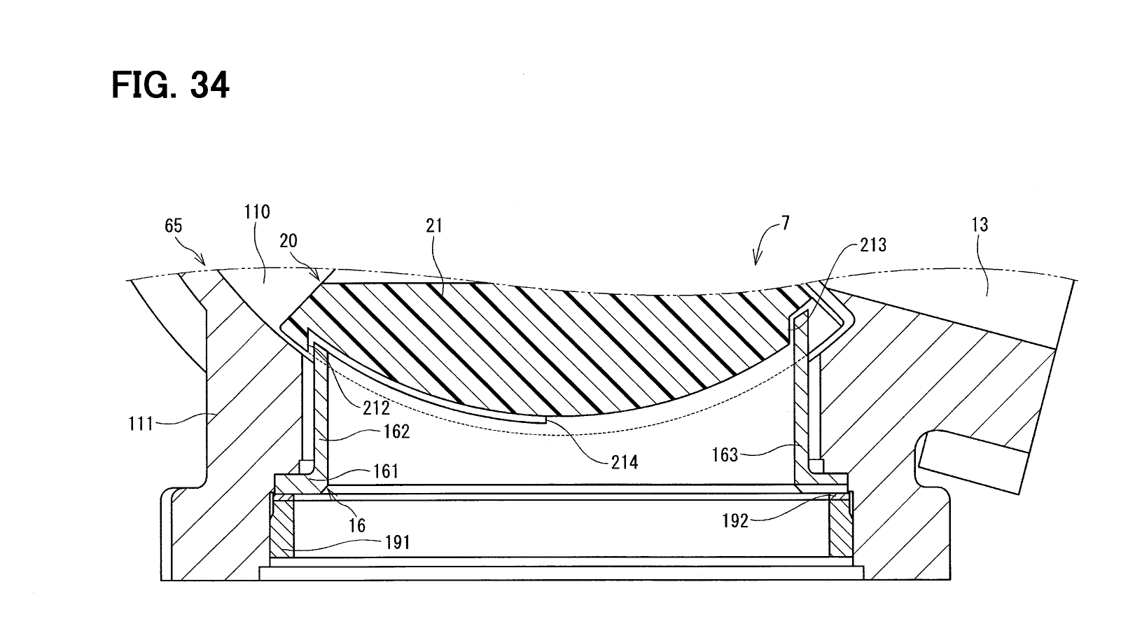

Next, the valve device of the seventh embodiment will be described with reference to FIG. 34. The seventh embodiment differs from the first embodiment with respect to the construction of the tubular body. Portions, which are substantially the same as those of the first embodiment, will be indicated by the same reference signs and will not be described redundantly for the sake of simplicity.

A valve device 7 of the seventh embodiment includes the valve housing 65, the valve member 20, the shaft 31, the drive device 35, the gear arrangement 37, the limiter portion 41 and the contact portion 42. The structure of the valve housing 65 is the same as that of the sixth embodiment.

In the valve device 7 of the seventh embodiment, when the valve member 20 is rotated in the EGR passage closing direction from the state where the EGR passage 950 is opened, the seal surface 212 of the valve member 20 contacts the first side wall portion 162 of the tubular member 16, and the seal surface 213 of the valve member 20 contacts the second side wall portion 163 of the tubular member 16, as shown in FIG. 34. In this way, the EGR passage 950 is blocked. Specifically, in the seventh embodiment, the EGR passage 950 is blocked through the contact between the tubular member 16 made of the metal and the valve member 20 made of the resin. At this time, the limiter portion 41 and the contact portion 42 contact with each other, so that the rotation of the valve member 20 in the EGR passage closing direction is limited.

The valve device 7 of the seventh embodiment includes the limiter portion 41 and the contact portion 42. Thus, the seventh embodiment achieves the advantages, which are the same as the advantages of the first embodiment.

In the valve device 7 of the seventh embodiment, the tubular member 16 is made of metal. In this way, the valve device 7 of the seventh embodiment can improve the heat resistance of the tubular member 16, in which the gas having the relatively high temperature flows.

A coefficient of elasticity of a region around a portion of each seal surface 212, 213 of the valve member 20, which is configured to contact the corresponding one of the first side wall portion 162 and the second side wall portion 163, is smaller than a coefficient of elasticity of the corresponding one of the first side wall portion 162 and the second side wall portion 163. In this way, in the valve device of the seventh embodiment, it is possible to limit a damage of the valve member 20 and the tubular member 16, which collide with each other every time the EGR passage 950 is blocked.

Furthermore, in the valve device 7 of the seventh embodiment, when the valve member 20 and the tubular member 16 contact with each other, i.e., when the region around the portion of each seal surface 212, 213 of the valve member 20 having the smaller coefficient of elasticity in comparison to the coefficient of elasticity of the tubular member 16 is not elastically deformed, the rotation of the valve member 20 is limited. In the valve device 7 of the seventh embodiment, with respect to the positional relationship between the limiter portion 41 and the contact portion 42, the start position P1 and the limiting position P3 discussed in the first embodiment coincide with each other. In this way, in the valve device of the seventh embodiment, in which the tubular member 16 made of the metal and the valve member 20 made of the resin are configured to contact with each other, it is possible to limit application of excess stress to the first side wall portion 162 and the second side wall portion 163 of the tubular member 16 and the portion of the seal surfaces 212, 213 of the valve member 20. Thus, the valve device 7 of the seventh embodiment can limit the secular change of the sealing performance.

### Other Embodiments

In the above embodiments, the valve member is shaped into the cylindrical tubular form. However, the shape of the valve member should not be limited to this form. For instance, the valve member may be shaped into a spherical form.

In the first and second embodiments, the limiter portion is threadably engaged with the valve housing. However, the limiter portion may not be threadably engaged with the valve housing.

In the first to sixth embodiments, one of the valve-housing-side seal portion and the valve-member-side seal portion is made of the elastic material. However, both of the valve-housing-side seal portion and the valve-member-side seal portion may be made of the elastic material.

In the first to fourth embodiments, the contacting part of the valve-housing-side seal portion, which is configured to contact the valve-member-side seal portion, is shaped into the lip form. Furthermore, in the fifth embodiment, the contacting part of the valve-housing-side seal portion, which is configured to contact the valve-member-side seal portion, is shaped into the column form. However, the shape of the contacting part of the valve-housing-side seal portion, which is configured to contact the valve-member-side seal portion, should not be limited to the above-described form.

In the case where the EGR passage is blocked through the contact between the tubular member made of the metal and the valve member made of the resin like in the valve device of the seventh embodiment, the sealing performance of the valve device can be improved by forming the contacting part of the tubular member or the contacting part of the valve member, which are configured to contact with each other, in a form of a leaf spring.

The present disclosure should not be limited to any of the above embodiments and may be implemented in various forms without departing from the scope of the present disclosure.

What is claimed is:

1. A valve device comprising:
a valve housing that includes:
a plurality of flow passages, through which fluid is flowable;
a communication space, through which the plurality of flow passages is communicated relative to each other; and
a valve-housing-side seal portion that is placed around an opening, which communicates between one of the plurality of flow passages and the communication space;
a valve member that is shaped into a tubular form or a spherical form and is rotatable relative to the valve housing, wherein the valve member includes a valve-member-side seal portion that blocks communication between the one of the plurality of flow passages and the communication space when the valve-member-side seal portion contacts the valve-housing-side seal portion;
a limiter portion that is formed separately from the valve-housing-side seal portion and is immovable relative to the valve housing; and
a contact portion that is formed separately from the valve-member-side seal portion and is rotatable synchronously with rotation of the valve member relative to the valve housing, wherein the contact portion is configured to limit rotation of the valve member relative to the valve housing when the contact portion contacts the limiter portion.

2. The valve device according to claim 1, further comprising:
a drive device that is configured to generate a torque that is capable of rotating the valve member; and
a gear arrangement that is configured to transmit the torque generated from the drive device to the valve member,
wherein the contact portion is provided at the gear arrangement.

3. The valve device according to claim 2, further comprising a shaft that is configured to rotate integrally with the valve member, wherein:
the gear arrangement includes a valve gear while the valve gear is rotatable integrally with the shaft and has an outer diameter, which is larger than an outer diameter of the shaft; and
the contact portion is provided to a radially outer end portion of the valve gear.

4. The valve device according to claim 1, further comprising a shaft that is configured to rotate integrally with the valve member, wherein:
the limiter portion is provided to an inner wall of a through-hole of the valve housing, into which the shaft is inserted; and
the contacting portion is provided to the shaft.

5. The valve device according to claim 1, wherein:
the limiter portion is provided to an inner wall that forms the communication space; and
the contact portion is provided to an end portion of the valve member in a rotational direction of the valve member.

6. The valve device according to claim 1, wherein:
the limiter portion is placed adjacent to the valve-housing-side seal portion of the valve housing; and
the contact portion is placed adjacent to the valve-member-side seal portion of the valve member.

7. The valve device according to claim 1, wherein the limiter portion is threadably engaged with and is thereby secured to the valve housing.

8. The valve device according to claim 1, wherein the valve-housing-side seal portion is made of an elastic material.

9. The valve device according to claim 8, wherein the valve-housing-side seal portion includes a lip portion while the lip portion is shaped into a lip form and is contactable with the valve-member-side seal portion.

10. The valve device according to claim 8, wherein the valve-housing-side seal portion includes a projection while the projection is shaped into a column form and is contactable with the valve-member-side seal portion.

11. The valve device according to claim 1, wherein the valve-member-side seal portion is made of an elastic material.

12. The valve device according to claim 8, wherein the limiter portion and the contact portion contact with each other when the valve-housing-side seal portion or the valve-member-side seal portion is elastically deformed.

13. The valve device according to claim 1, wherein the valve-housing-side seal portion and the valve-member-side seal portion are respectively made of different materials, which respectively have different coefficients of elasticity that are different from each other.

14. The valve device according to claim 13, wherein the limiter portion and the contact portion contact with each other before the valve-housing-side seal portion or the valve-member-side seal portion is elastically deformed.

15. The valve device according to claim 13, wherein the valve-housing-side seal portion is made of metal.

16. A manufacturing method of a valve device that includes:
a valve housing that includes:
a plurality of flow passages, through which fluid is flowable;
a communication space, through which the plurality of flow passages is communicated relative to each other; and
a valve-housing-side seal portion that is placed around an opening, which communicates between one of the plurality of flow passages and the communication space;
a valve member that is shaped into a tubular form or a spherical form and is rotatable relative to the valve housing, wherein the valve member includes a valve-member-side seal portion that blocks communication between the one of the plurality of flow passages and the communication space when the valve-member-side seal portion contacts the valve-housing-side seal portion;
a limiter portion that is formed separately from the valve-housing-side seal portion and is immovable relative to the valve housing; and
a contact portion that is formed separately from the valve-member-side seal portion and is rotatable synchronously with rotation of the valve member relative to the valve housing, wherein the contact portion is configured to limit rotation of the valve member relative to the valve housing when the contact portion contacts the limiter portion, the manufacturing method comprising:
a positioning step of determining a position of the valve-housing-side seal portion relative to the valve member by using a positioning jig that is fittable to both of the valve member and the valve-housing-side seal portion.

17. A manufacturing method of a valve device that includes:
a valve housing that includes:
a plurality of flow passages, through which fluid is flowable;
a communication space, through which the plurality of flow passages is communicated relative to each other; and
a valve-housing-side seal portion that is placed around an opening, which communicates between one of the plurality of flow passages and the communication space;
a valve member that is shaped into a tubular form or a spherical form and is rotatable relative to the valve housing, wherein the valve member includes a valve-member-side seal portion that blocks communication between the one of the plurality of flow passages and the communication space when the valve-member-side seal portion contacts the valve-housing-side seal portion;
a limiter portion that is formed separately from the valve-housing-side seal portion and is immovable relative to the valve housing; and
a contact portion that is formed separately from the valve-member-side seal portion and is rotatable synchronously with rotation of the valve member relative to the valve housing, wherein the contact portion is configured to limit rotation of the valve member relative to the valve housing when the contact portion contacts the limiter portion, the manufacturing method comprising:
a positioning step of determining a position of the valve-housing-side seal portion relative to the valve member by urging a valve-member-side step surface of the valve-member-side seal portion and a valve-housing-side step surface of the valve housing against with each other.

18. The manufacturing method of the valve device according to claim 17, wherein:
one of the valve-housing-side seal portion or the valve-member-side seal portion includes a lip portion or a projection, which is made of an elastic material and is formed to project in a circumferential direction of the valve member;
the other one of the valve-housing-side seal portion or the valve-member-side seal portion includes a seal surface that faces in the circumferential direction of the valve member and is contactable with the lip portion or the projection; and
the positioning step includes adjusting a thrust direction of the valve-housing-side seal portion relative to the valve member by urging the seal surface against the lip portion or the projection.

19. The manufacturing method of the valve device according to claim 17, wherein:
the valve housing includes:
a casing that includes the plurality of flow passages and the communication space;
the valve-housing-side seal portion that is formed separately from the casing; and
a fixation member that is configured to fix the valve-housing-side seal portion to the casing; and
the manufacturing method comprises:
a provisional press fitting step of provisionally press fitting the fixation member to the casing before the positioning step; and
an actual press fitting step of actually press fitting the fixation member to the casing after the positioning step.

20. The manufacturing method of the valve device according to claim 17, further comprising a provisional fixing step of provisionally fixing the valve-housing-side seal portion through use of a weight jig before the positioning step.
